(19) United States
(12) Patent Application Publication
(10) Pub. No.: US 2025/0256818 A1
(43) Pub. Date: Aug. 14, 2025

(54) PRESSURE REDUCER FOR SCBA

(71) Applicant: 3M INNOVATIVE PROPERTIES COMPANY, St. Paul, MN (US)

(72) Inventor: Graham Langford, Wirral (GB)

(21) Appl. No.: 18/832,902

(22) PCT Filed: Feb. 1, 2023
(86) PCT No.: PCT/IB2023/050888

§ 371 Date: Jul. 24, 2024

Related U.S. Application Data
(60) Provisional application No. 63/308,638, filed on Feb. 10, 2022.

(51) Int. Cl. B63C 11/22

(52) U.S. Cl. CPC B63C 11/2236; B63C 2011/2281

(57) ABSTRACT

A pressure reducer for a self-contained breathing apparatus (SCBA). The reducer may include an integrated pneumatic alerting device with an upstream antechamber, and an integral refill air passage with a first end that is fluidically connected to a refill air inlet of the reducer and with a second, opposing end that is fluidically connected to the upstream antechamber of the integrated pneumatic alerting device.

### BACKGROUND

A self-contained breathing apparatus (SCBA) is an apparatus generally used to provide respiratory protection to a person that may be entering an objectionable, oxygen-deficient, and/or otherwise potentially unbreathable or toxic environment. Such apparatuses typically comprise at least one high-pressure air tank, and often include one or more devices designed to alert the user e.g. when the tank air has been depleted to a certain level.

### SUMMARY

In broad summary, herein is disclosed a pressure reducer for a self-contained breathing apparatus (SCBA). In one aspect, the reducer may comprise an integrated pneumatic alerting device with an upstream antechamber, and an integral refill air passage with a first end that is fluidically connected to a refill air inlet of the reducer and with a second, opposing end that is fluidically connected to the upstream antechamber of the integrated pneumatic alerting device. These and many other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a rear view of an exemplary SCBA.

FIG. 2 is a rear view of an exemplary SCBA harness.

FIG. 3 is a side view of an exemplary SCBA harness.

FIG. 4 is a side view of a lower end of a backframe, reducer, and air tank of an exemplary SCBA.

FIG. 5 is a rear view of a lower end of a backframe, and a reducer, of an exemplary SCBA harness.

FIG. 6 is a rear view of a lower end of a backframe, and a reducer, of an exemplary SCBA harness.

FIG. 7 is a perspective view of an exemplary reducer of an SCBA.

FIG. 8 is a perspective view of an exemplary reducer, from a different viewing angle.

FIG. 9 is a schematic cross-sectional view of an exemplary reducer.

FIG. 10 is a schematic cross-sectional view of an exemplary reducer, from a different viewing angle.

FIG. 11 is a perspective view of a main body of an exemplary reducer.

FIG. 12 is a schematic cross-sectional view of a main body of an exemplary reducer.

FIG. 13 is a schematic cross-sectional view of a main body of an exemplary reducer, from a different viewing angle.

FIG. 14 is a schematic cross-sectional view of an exemplary reducer, from another viewing angle.

FIG. 15 is a schematic cross-sectional view of an exemplary reducer, from still another viewing angle.

FIG. 16 is a side view of a lower end of a backframe, and a reducer, of an exemplary SCBA harness.

FIG. 17 is a perspective view of an exemplary connecting assembly that can be used to connect an air tank to a reducer of an SCBA.

Like reference numbers in the various figures indicate like elements. Some elements may be present in identical or equivalent multiples: in such cases only one or more representative elements may be designated by a reference number but it will be understood that such reference numbers apply to all such identical elements. All figures and drawings are not to scale and are chosen for the purpose of illustrating different embodiments of the invention. The dimensions of various components are depicted in illustrative terms only, and no relationship between the dimensions of the various components should be inferred from the drawings.

Although terms such as “first” and “second” may be used in this disclosure, it should be understood that those terms are used in their relative sense only unless otherwise noted. The term “configured to” and like terms is at least as restrictive as the term “adapted to”, and requires actual design intention to perform the specified function rather than mere capability of performing such a function. All references herein to numerical values (e.g. dimensions, ratios, and so on), unless otherwise noted, are understood to be calculable as average values derived from an appropriate number of measurements.

As used herein as a modifier to a property or attribute, the term “generally”, unless otherwise specifically defined, means that the property or attribute would be readily recognizable by a person of ordinary skill but without requiring a high degree of approximation. In particular, the term “generally” as applied to an angular orientation means within plus or minus 30 degrees of the “exact” orientation: for example, an item that is described as generally vertically-oriented will be oriented within plus or minus 30 degrees of the vertical axis of the herein-described harness. It will be understood that in all instances in which the term “generally” appears, the term subsumes any and all more-exact orientations. e.g. an orientation that is within plus or minus 10 degrees of “exact”, or that approaches being truly “exact”.

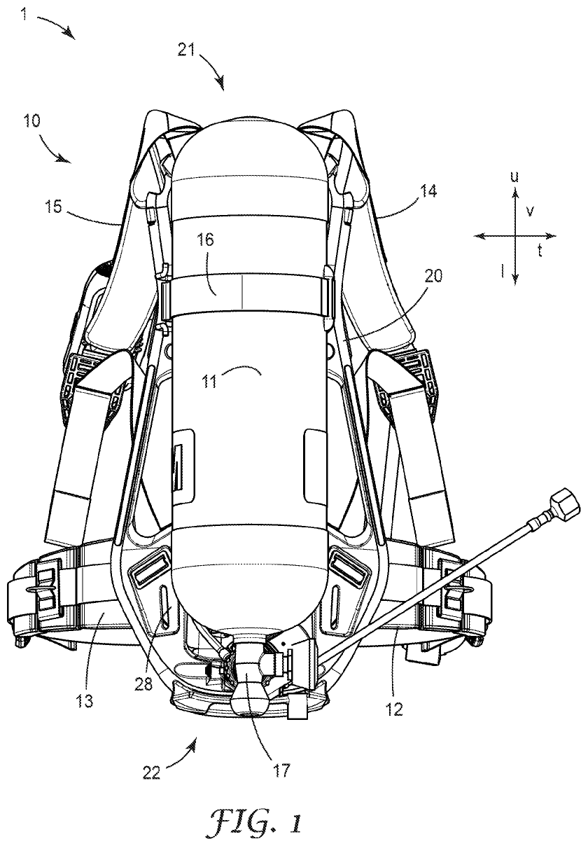

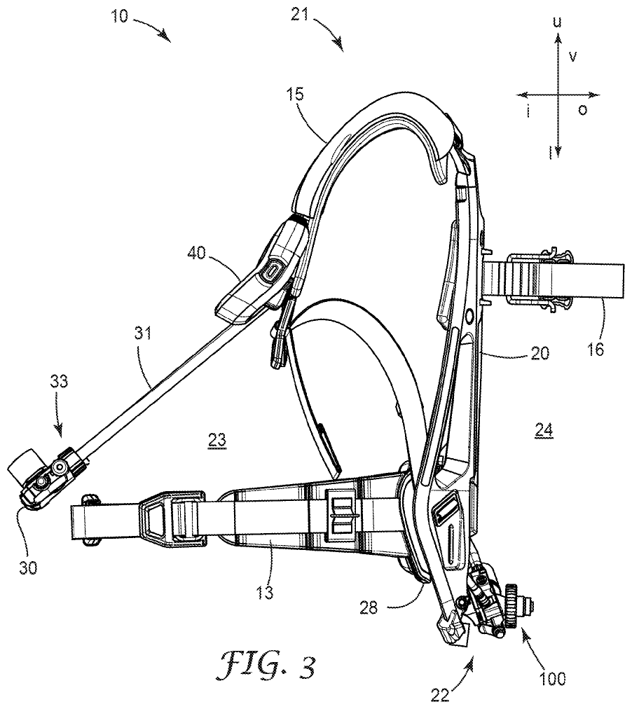

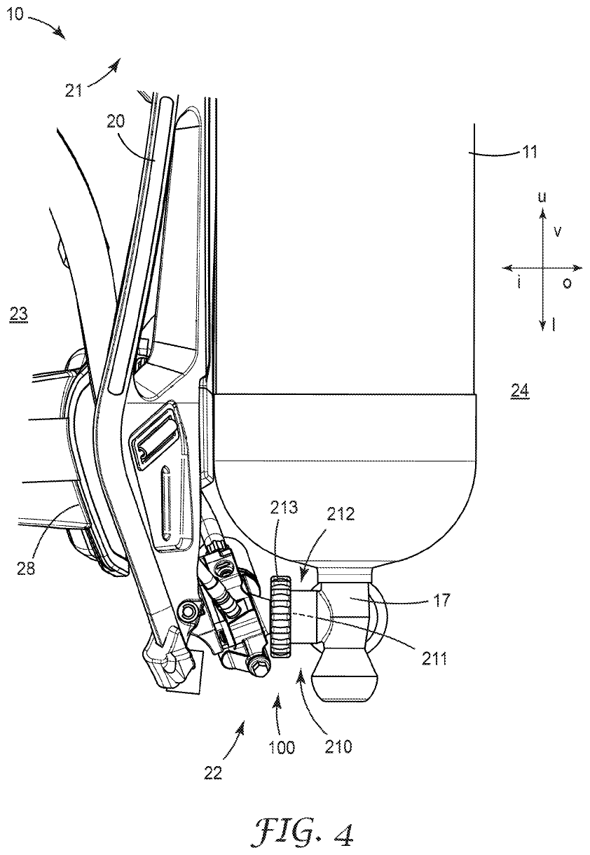

The following terminology is defined with respect to an SCBA harness as worn by a user standing upright, and to components of the harness and various items (e.g. a reducer, various hoses, etc.) that are connected to the harness. This terminology is used for case of description and does not limit the actual orientation of the harness and items installed thereon during actual use. Terms such as vertical, upward and downward, upper, lower, above, and below, and like terminology, correspond to conventional directions with respect to the Earth when the harness is worn by a user who is standing upright. The upward (u) and downward (d) directions along the vertical axis (v) are denoted in FIG. 1 and in various other Figures. The term outward denotes a generally horizontal direction that is generally perpendicular to the vertical axis and is away from the body (e.g. the dorsal and lumbar areas) of a user of the harness. The term inward denotes a generally opposing direction, toward the body (e.g. the dorsal and lumbar areas) of the user of the harness. Inward and outward directions (i) and (o), and an inward-outward axis defined thereby, are indicated in FIGS. 3 and 4 and in various other Figures. Many of the items and components of an SCBA as discussed herein will be positioned on the rear side of the torso of a user of the SCBA: therefore, terms such as “rear” and “front” may occasionally be used to respectively denote “outward” and “inward” sides or directions. The term lateral denotes a generally horizontal, left-right axis that is generally perpendicular to the vertical and inward-outward directions. The lateral axis is equivalent to the transverse axis, noting that in the Figures the symbol “t” (for transverse) is used to indicate this axis, so as to not cause confusion with the “l” that is used to designate the “lower” direction along the vertical axis. Specific terminology that is used to describe a pressure reducer will be presented later herein, when the topic of reducer design is discussed in detail.

### DETAILED DESCRIPTION

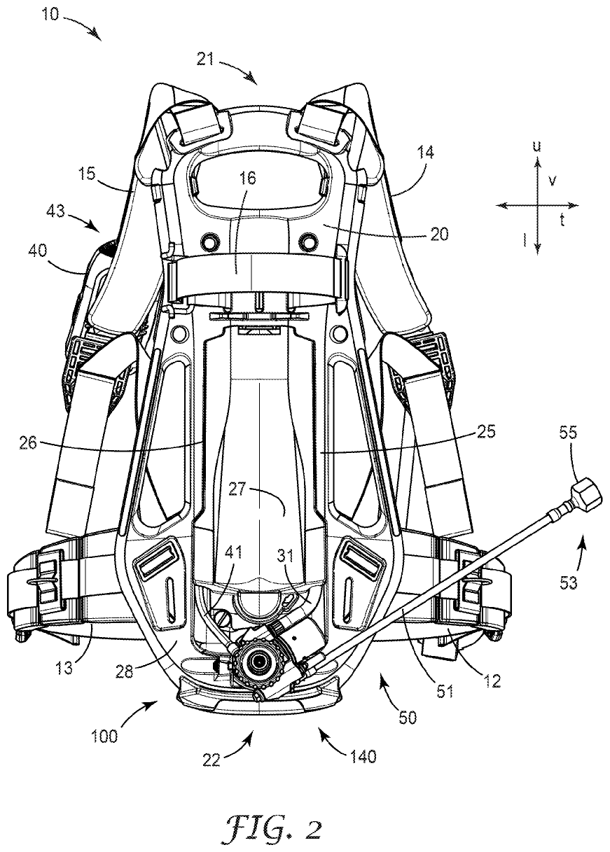

Shown in FIG. 1 is an exemplary self-contained breathing apparatus (SCBA) 1 arranged to deliver breathable air to a human user of the apparatus. Apparatus 1 comprises one or more tanks (e.g. cylinders) 11 comprising a high-pressure breathable gas or gaseous mixture, most commonly compressed air (such tanks and their contents will be referred to respectively herein as air tanks and air, regardless of their specific contents). The air tank(s) 11 are supported on an SCBA harness 10 comprising various straps, support plates, buckles, and so on, by which the harness can be donned so that the air tank(s) can be comfortably supported e.g. on the back of the user. In the depicted embodiments (noting that FIGS. 2 and 3 depict an SCBA harness without an air tank so that other items may be more easily seen), harness 10 comprises a backframe 20 with a top end 21 and a lower end 22, and with an inward (front) side 23 and an outward (rear) side 24. Harness 10 further comprises first and second (e.g. right and left) lateral waist strap sections 12 and 13 that collectively encircle the user's waist and/or hip area and are attached to each other; and, first and second shoulder straps 14 and 15 that pass over the user's shoulders. Such straps are connected to backframe 20 so that backframe 20, and an air tank 11 secured thereto, can be supported. An air tank strap 16 may be provided to enhance the security with which the air tank 11 is held in place on the rear side of the backframe 20. (Backframe 20 may be made of e.g. metal, molded plastic, or any combination or assembly thereof, and in some embodiments may be rigid.)

An SCBA will comprise a facemask and associated hoses and equipment so that breathable air can be supplied to the facemask. This equipment will include an in-line first-stage regulator 100 which will be referred to herein as a pressure reducer or, simply, a reducer. A reducer 100 may be conveniently located proximate the lower end 22 of backframe 20, as evident in FIG. 2. The reducer will thus be positioned to be connected to the lower end of an air tank 11, with the air tank comprising a valved fixture 17 to facilitate the connecting of the reducer to the air tank. Reducer 100 will be connected (e.g., removably connected) to the lower end 22 of backframe 20. In some embodiments, reducer 100 may be a load-bearing item that, in addition to other uses discussed herein, may support at least some of the weight of the air tank and may transmit a significant portion of the force resulting from the weight of the air tank, to the backframe. In various embodiments, a reducer may be configured to transmit at least 40, 60, or 80% of the weight of the air tank to the backframe.

Reducer 100 may be connected to air tank 11 by a connecting assembly. Such a connecting assembly can establish a fluidic pathway whereby high-pressure air from the tank can enter reducer 100, and can also establish a robust mechanical connection between the reducer and the air tank. In some embodiments, such a connecting assembly may comprise a fitting that is fixed in a high-pressure air inlet of the reducer in combination with a fitting that is fixed in an outlet of a valve that is fixed in an opening of the air tank, the two fittings being designed to connect together securely, but separably. An exemplary connecting assembly 210 is indicated in FIG. 4: various connecting assemblies are discussed in detail later herein.

Reducer 100 will receive high-pressure tank air from tank 11 and will reduce the pressure of the air from the tank pressure (which may be up to e.g. 379 bar) to an intermediate pressure (which may be in the range of e.g. 8 bar). The reducer then delivers the air at this intermediate pressure to one (or more) delivery outlets of the reducer (thus, this intermediate pressure at which the air is delivered to a delivery outlets will be referred to herein as an “outlet” pressure). The outlet-pressure air is delivered through a delivery outlet of reducer 100 into a delivery hose 31, which conveys the air to a second-stage, mask-mountable regulator 30. As shown in FIGS. 2 and 3, a delivery hose 31 may comprise a first end 32 that is fixed to a delivery outlet of reducer 100, with delivery hose 31 being routed generally upward from reducer 100 along backframe 20. Delivery hose 31 may then pass over the user's shoulder: hose 31 will comprise a second, opposing end 33 that is coupled (by way of any suitable fitting) to mask-mountable regulator 30.

Mask-mountable regulator 30, when suitably mounted on a facemask of the SCBA, further reduces the pressure of the air from the outlet pressure to a pressure suitable for breathing (e.g. to near-atmospheric pressure) and delivers it to the facemask. Such a facemask will define an interior volume (air space) when fitted to the face of a human user, and will comprise one or more couplers, connections or fittings that allow mask-mountable regulator 30 to be mounted on, and fluidly connected to, the facemask, so that mask-mounted regulator 30 can deliver breathable air into the interior volume of the facemask. In some embodiments, the breathable air may be delivered into a nosecup that covers the nose and mouth of the wearer.

In some embodiments, a mask-mounted regulator 30 may be an “on-demand” regulator that provides airflow in response to inhalations of the user. Typically, such a regulator may include a housing within which a diaphragm is disposed, the diaphragm being coupled to a demand valve. The user's respiration creates a pressure differential that causes displacement of the diaphragm thereby controlling (e.g., opening and closing) the demand valve. In some embodiments, such a regulator may be an “on-demand, positive-pressure” regulator that maintains the air in the interior volume of the facemask at a slightly elevated pressure (relative to the ambient air pressure) while replenishing this air on an on-demand basis in response to the user's breathing. Various mask-mountable regulators of this and other types are described in detail e.g. in U.S. Pat. No. 4,345,592, 4,269,216, 6,095,142, and 6,394,091. Regulators are also described in U.S. Provisional Patent Application 62/879,279 and in the resulting International (PCT) Patent Application Publication WO 2021/019348, both of which are incorporated by reference in their entirety herein. It is emphasized however that the arrangements disclosed in the present application are not limited to being used with any particular type or design of mask-mountable regulator, or facemask.

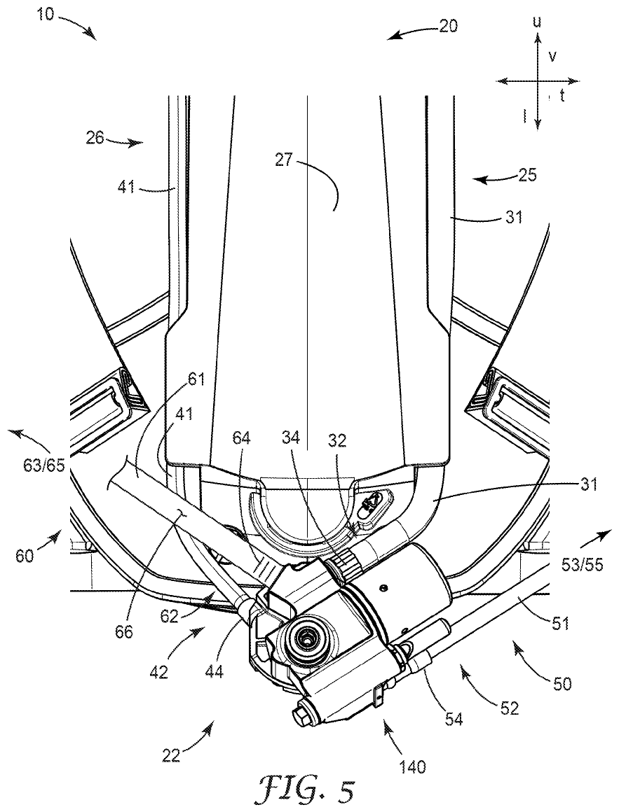

In some embodiments, SCBA harness 10 may comprise a high-pressure gauge 40 that is configured to monitor the pressure in the high-pressure air tank 11. (The particular gauge 40 seen e.g. in FIG. 3 is provided as part of an electronic console that may serve one or more additional functions, depending on the configuration.) As discussed in detail later herein, high-pressure gauge 40 will receive high-pressure air via reducer 100 rather than directly from a fitting of the air tank 11 or via any other air pathway that does not pass through reducer 100. To facilitate this, harness 10 may comprise a high-pressure gauge hose 41 with a first end 42 (seen most easily in FIG. 5) comprising a fitting 44 that is fixedly inserted in a high-pressure gauge air outlet of reducer 100. High-pressure gauge hose 41 may be routed generally upward from reducer 100 along backframe 20 in similar manner as described above for delivery hose 31, and may similarly pass over the user's shoulder. (Typically, high-pressure gauge hose 41 and delivery hose 31 will pass over opposite shoulders, as evident in FIG. 2.) Pressure gauge hose 41 will comprise a second, opposing end 43 which is fluidically connected to high-pressure gauge 40. In some convenient embodiments, high-pressure gauge 40 may be removably installed on harness 10, e.g. removably mounted on a shoulder strap thereof so that the gauge can be easily seen by the user.

In some embodiments, SCBA harness and reducer as disclosed herein may comprise a pneumatic alerting device 140 (indicated in general in FIG. 2, and discussed in detail later herein). Alerting device 140 will be activated in the event that the high-pressure air in the air tank falls below a predetermined threshold value. That is, such a device will emit an audible warning signal if the pressure in the air tank falls below a particular level (e.g., if the pressure falls below approximately 55 bar). A “pneumatic” alerting device by definition is a non-electrically powered device that functions (e.g. emits an audible warning signal) based on the flow of high-pressure air. As disclosed herein, a pneumatic alerting device 140 will be an integrated device of reducer 100. By “integrated” (here and elsewhere in this disclosure) is meant a device or assembly that is part of reducer 100, i.e. is contained at least partially or wholly within one or more cavities or openings of the reducer itself. This is distinguished from a device that is at a separate location of harness 10 from the reducer and that operates by way of air supplied through an air hose external to the reducer. Rather, integrated pneumatic alerting device 140 will operate by way of high-pressure air that reaches device 140 from an interior air pathway of reducer 100.

In some embodiments, an SCBA harness and reducer as disclosed herein may comprise a rescue breathing system 60, indicated in general in FIG. 5 and discussed in further detail later herein. Such a rescue-breathing system is sometimes referred to as a buddy breathing system, a Rescue Second Person system, or an Emergency Breathing Support system. Such a system is arranged so that a first SCBA (referred to herein as a “donor” SCBA) can provide air to a second, recipient SCBA (referred to herein as a “donee” SCBA). It will be appreciated that such an arrangement is typically only used in an emergency (e.g. in the case that a donee SCBA is out of air and the user of that SCBA cannot immediately get to a location with breathable ambient air) or for training purposes, and is only used for a short time since using the donor SCBA for “double-duty” in this manner will rapidly deplete the air tank of the donor SCBA.

A rescue-breathing system 60, if present, will comprise a rescue-breathing hose 61 with a first end 62 comprising a first fitting 64 that is fixedly inserted in a delivery outlet of reducer 100, and with a second end 63 comprising a second fitting 65 that is configured to be fluidically connected to a fitting of a donee SCBA. (Second fitting 65 will typically be a normally-closed fitting that provides a fluidic dead-end so that there is no airflow down hose 61 unless the hose is in actual use e.g. for rescue-breathing purposes). Rescue-breathing hose 61 will receive air from reducer 100 at the above-described outlet pressure. (This brief description is with reference to the herein-described SCBA serving as a donor SCBA; it is of course possible for this SCBA to be a donee.) An exemplary rescue-breathing system 60 is indicated in part in FIG. 5. In practice, rescue-breathing hose 61 may be routed along a second lateral section (e.g. a left section 13, in the exemplary illustration of FIG. 5) of a waist strap of the SCBA harness 10, and may be removably secured to the waist strap at least at one location. Such an arrangement can keep hose 61 and its fitting 65 in a location in which it does not impede the user of the harness, but in which the fitting 65 can be quickly and easily accessed if it is desired to use the rescue-breathing system.

In some embodiments, an SCBA harness and reducer as disclosed herein may comprise an air refill system 50 (often referred to as a fast-fill system). Such a system can allow an air tank 11 to be refilled with high-pressure breathing air from an outside source (e.g. from an air compressor), without necessitating that the air tank be removed from the harness or even disconnected from the reducer 100. A refill system 50, if present, will comprise a refill hose 51 with a first end 52 comprising a first fitting 54 that is fixedly inserted in a refill air inlet of reducer 100, and with a second, opposing end 53 comprising a second fitting 55 that is configured to be removably fluidically connected to an outside source of refill air. Such a refill system 50 will typically comprise a one-way valve that allows flow of refill air into the refill air inlet of the reducer and through an air pathway of the reducer as described in detail later herein, but does not allow air to exit out of the refill air inlet. In some embodiments, a one-way valve may be provided within the fitting 54 of refill hose 51 for this purpose.

An air refill system 50 as disclosed herein will refill a depleted air tank by sending high-pressure refill air through various internal air passages of reducer 100. Detailed discussions later herein will reveal that such an arrangement requires the refill air to flow “backwards” through at least some internal air passages of the reducer. That is, the refill air will flow in a reverse direction to that in which high-pressure air normally flows when being sent from the air tank through the reducer on its way to a mask-mounted regulator. An exemplary refill system 50 is indicated in FIG. 2, noting that for case of presentation the refill hose 51 is shown extending straight out. In practice, refill hose 51 may be routed along a first lateral section (e.g. a right section 12) of a waist strap of the SCBA harness, and may be removably secured to the waist strap at least at one location. Such an arrangement can keep hose 51 and its fitting 55 in a location in which it does not impede the user of the harness, but in which the fitting 55 can be quickly and easily accessed if it is desired to refill the air tank. In some embodiments, harness 10, reducer 100, and air tank 11 may be configured so that a depleted air tank can be removed and replaced by a fresh air tank, rather than the depleted air tank being refilled with high-pressure air in the manner described above. In some embodiments, these items may be configured so that a depleted air tank can be refilled, or can be swapped out, depending on the particular circumstances or preferred operating practice of the user.

In some embodiments, an SCBA harness and reducer as disclosed herein may be configured in another way to accept breathing air from an outside source. However this air will not be at high pressure and will not be for the purpose of refilling the air tank of the SCBA. Rather, such an arrangement may allow the SCBA to receive air at a pressure in the range of the previously-described outlet pressure (e.g., up to approximately 8 bar). The air may be received through an air hose of similar type to the above-described air hose 61; the received air may enter the reducer 100 and then be sent from there to a mask-mounted regulator in the general manner described elsewhere herein. In such a case, a second end 63 of the receiving hose 61 may be connected to an umbilical that provides air from an outside source. In such cases, a receiving hose 61 and/or an umbilical outside-air-supplying hose to which it is connected, are often referred to as an “airline”: so, an SCBA harness and reducer that are configured to be able to receive outside air in this manner will be referred to herein as being “airline-ready”. In some embodiments, an air hose 61 may be configured (e.g. with two separate fittings in parallel at its second end) so that the same air hose can serve as a rescue-breathing hose or as an “airline” hose, depending on the situation of current use. Also, in some embodiments, an SCBA harness and reducer may be configured to be both airline-ready and to include an above-described air (tank)-refill system 50: the two systems are not mutually exclusive.

In some cases, such arrangements may be used to provide outside air in a supplemental, limited-use, and/or backup manner. In some cases, the outside air may be relied on for extended use (e.g. with the SCBA air tank serving as a backup supply). Such arrangements may be used, for example, in combination with a hazmat suit to allow extended usage in extreme environments. Such hazmat suits (for example, gas-tight garments available e.g. from Respirex Corporation, and made of e.g. TYCHEM or TYVEK barrier materials as available from DuPont de Nemours) may include a pass-through port that allows an airline to enter the suit while maintaining the suit's barrier properties.

### Reducer

The above discussions reveal that in various embodiments, a reducer 100 as disclosed herein may have up to e.g. four hoses connected thereto: a delivery hose 31 to deliver air at an outlet pressure to a mask-mountable regulator: a high-pressure gauge hose 41 to deliver air at a high (tank) pressure to a high-pressure gauge: a rescue-breathing hose 61 (or airline hose) that can deliver air at outlet pressure to a donee SCBA and/or receive air at outlet pressure from an outside source; and, a refill hose 51 that can receive high-pressure air from an outside source in order to refill the air tank of the SCBA. An exemplary reducer 100 with four such hoses connected thereto is depicted in exemplary embodiment in FIG. 5; specific exemplary arrangements and orientations of such hoses that provide particular advantages will be discussed in detail later herein.

In various embodiments, not all such hoses need necessarily be present, depending e.g. on the preferences of the user. Thus in various embodiments, any, some, or all of rescue-breathing capability, airline readiness, and air (tank)-refill capability may be optional functionalities. For example, an SCBA harness that is not equipped with a rescue-breathing system (and is not airline-ready) may comprise a reducer 100 that has a plug fixed in the appropriate outlet/inlet) of the reducer. Similarly, an SCBA harness that is not equipped with an air tank-refill system may comprise a reducer that has a plug fixed in the refill air inlet. It is emphasized however that the same basic reducer design may be used in all such cases. It will thus be appreciated that reducers designed in the manner described herein will possess the capability to be used in various ways, regardless of whether any particular reducer, as manufactured, is configured to actually perform any particular function or function.

Various exemplary arrangements disclosed herein. e.g. in which a high-pressure air gauge receives high-pressure air from the reducer, a pneumatic alerting device is integrated into the reducer, and/or in which an air refill system is configured to supply refill air to an air tank by way of the reducer, can provide significant advantages in reducing the complexity, weight, and so on, of the SCBA harness. That is, according to the disclosures herein, it may not be necessary to provide dedicated airflow pathways (e.g. hoses) between the air tank and a pressure gauge, the air tank and a pneumatic alerting device, the air tank and an air refill system, and/or the air tank and a rescue-breathing system. Rather, according to the disclosures herein, any or all such systems and items that are present, can leverage the presence of the reducer. This can significantly simplify the “plumbing” that is present external to the reducer; however, it is not a straightforward matter to arrange all of the necessary pathways, inlets and outlets, and so on, of the reducer, to allow such functionality, as will be made clear by the discussions that follow.

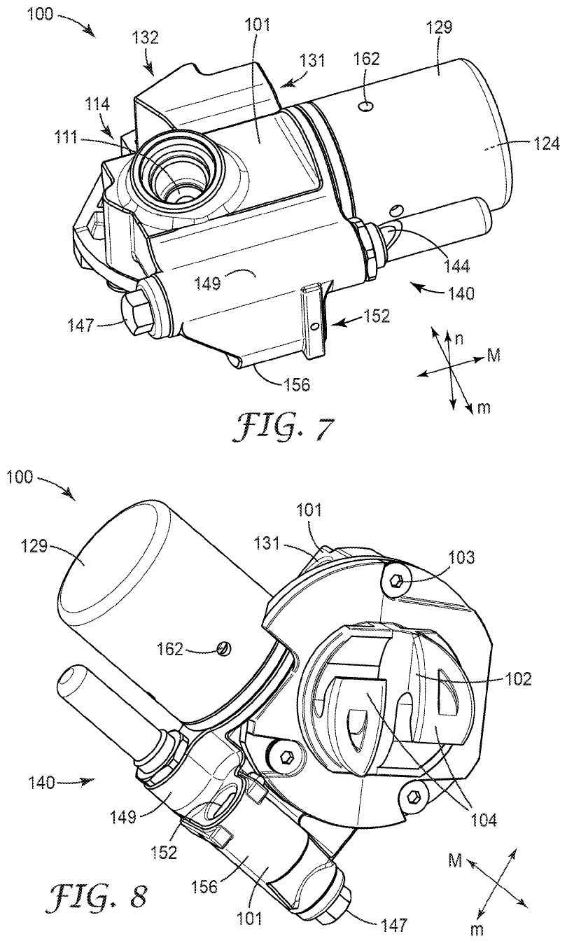

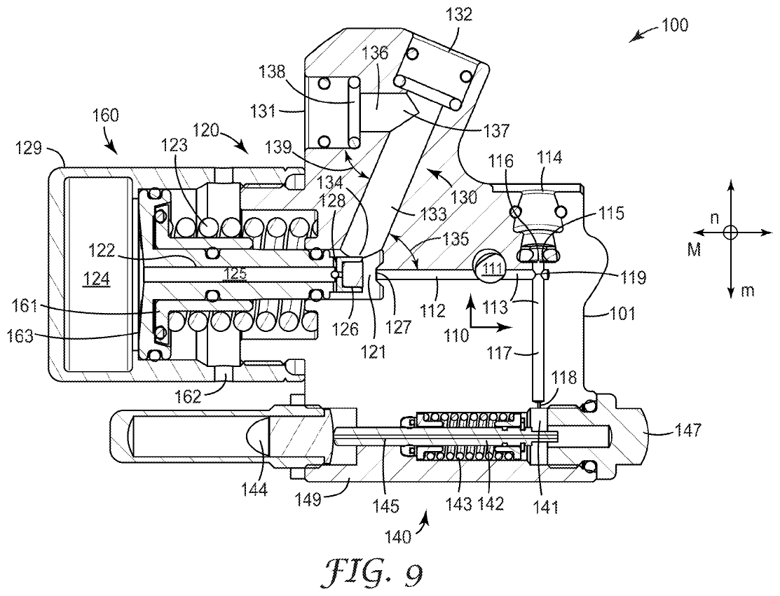

An exemplary reducer 100 as disclosed herein is depicted in two different perspective views in FIGS. 7 and 8, and in schematic cross-sectional view in FIG. 9. Reducer 100 will comprise a main body 101, which may be made of e.g. brass. e.g. nickel-coated brass, or similar material. Main body 101 will have various cavities, receptacles, passages, etc. provided therein (e.g. by way of a subtractive manufacturing process such as machining with a machine tool) as described in detail later herein. The cavities, receptacles, and so on, may then have various items inserted thereinto, and are configured to accept such items and to allow their functioning. The discussions that follow will describe many such items and their function; however, various items (e.g. O-rings, gaskets, plugs, springs, and so on) will not be described in detail, their functions, and how to configure them to achieve such functions, being readily understandable to the artisan with background knowledge of reducer design and functioning.

A reducer 100 will comprise a high-pressure air inlet 111 configured to receive high-pressure air from an air tank 11. e.g. by way of a connecting assembly as described elsewhere herein. With reference to FIG. 9, high-pressure air inlet 111 (an innermost portion of which is visible in FIG. 9) will be fluidically connected to a high-pressure air pathway 110 that includes at least a primary high-pressure air passage 112 that is fluidically connected to a metering assembly 120. The function of metering assembly 120 is to receive air at a high (tank) pressure and to meter it into an air-delivery pathway 130 at a lower, outlet pressure. Air-delivery pathway 130 leads to at least one air-delivery outlet (in the exemplary design of FIG. 9, there are two such outlets 131 and 132).

High-pressure air pathway 110 also includes a secondary high-pressure air passage 113 (that, in this case, has multiple portions that meet at an intersection 119) that is fluidically connected to a high-pressure gauge air outlet 114. Outlet 114 is configured to accept a fitting 44 of a hose 41 so that high-pressure air can be delivered to a high pressure gauge 40 as previously described. Secondary high-pressure air passage 113 is also fluidically connected to an integrated pneumatic alerting device 140.

Metering assembly 120 relies on a metering piston 122 that is elongate with a long axis and that comprises a platen (at the far left of the piston, in FIG. 9) that is biased (leftward, in FIG. 9) by a biasing spring 123. The stem and platen of piston 122 comprise an elongate through-bore 125 that allows high-pressure air from an upstream plenum 121 to pass through the elongate length of piston 122 to reach chamber 124 that is defined between the platen of piston 122, and a shroud or casing 129 that is fitted over this portion of the reducer. At times, a direct fluidic pathway exists between the high-pressure entry 127 from high-pressure air passage 112, and a first air-delivery passage 133 of an air-delivery pathway 130, by way of upstream plenum 121. (FIG. 9 is shown with such a condition being present.) However, once sufficient high-pressure air travels through piston bore 125 to reach chamber 124, the pressure in chamber 124 rises to a sufficient value (e.g., in the range of approximately 8 bar) that the force of the air on the platen of the piston overcomes the biasing force of biasing spring 123. At this time, the piston will move (rightward, in the view of FIG. 9) so that valve seat 126 of piston 122 seals off the high-pressure entry 127, so that high-pressure air can no longer enter plenum 121 or chamber 124 (and also cannot enter passage 133 of the air-delivery pathway).

With high-pressure entry 127 having been scaled, the pressure in the air-delivery pathway 130 will remain at the established value (e.g. an outlet pressure that is suitable for delivery of air to a mask-mounted regulator). Air-delivery pathway 130 is in fluidic communication (through a previously mentioned delivery hose 31) with the mask-mounted regulator of the SCBA. As the user of the SCBA breathes in and air is withdrawn from delivery hose 31 by the mask-mounted regulator, the pressure in delivery hose 31, and thus the pressure in the air-delivery pathway 130, will drop. One or more bypass apertures 128 are provided in piston 122 so that the pressure in bore 125 of piston 122, and in chamber 124 at the end of piston 122, will remain equilibrated with the pressure in the air-delivery pathway 130. (Such an arrangement will provide that plenum 121 is in fluidic communication with primary high-pressure air passage 112 in a manner that is interruptible by the movement of piston 122, while being in non-interruptible fluidic communication with first air-delivery passage 133 of air-delivery pathway 130.) Thus, as the pressure drops in air-delivery pathway 130 as a result of the user's breathing, the pressure will drop in chamber 124, such that this pressure can no longer overcome the opposing force of biasing spring 123. The biasing spring 123 will then urge the piston to a position in which seat 126 of the piston no longer seals entry 127. At this time, additional high-pressure air will enter plenum 121. (It is noted in passing that in FIG. 9 the “open” condition of piston 122. i.e. the distance between seat 126 and high-pressure air entry 127, is exaggerated: in reality, the opening and closing will involve movements of piston 122 over extremely short distances.) The above-described cycle will be repeated with the user's continued respiration. The overall result is that the metering assembly 120 will receive high-pressure air and will intermittently meter it into the air-delivery pathway, at a lower. “outlet” pressure, in response to the user's respiration.

Exemplary reducer 100 as depicted in FIG. 9 comprises another feature, which is a pressure relief assembly 160 that is integrated with metering assembly 120. Pressure relief assembly 160 relies on a pressure-relief piston 161 that is positioned in close proximity to the above-described piston 122 of metering assembly 120. Piston 161 is biased by the same spring 123 that biases piston 122. In fact, in normal operation of metering assembly 120, piston 161 remains in contact with piston 122, and the biasing of piston 122 by spring 123 occurs via force transmitted through the platen of piston 161. In other words, in normal operation of metering assembly 120, pistons 122 and 161 will remain in contact with each other, moving or remaining still in lockstep with each other. However, in the event of e.g. an incomplete closure of high-pressure entry 127 by valve seat 126 of piston 122, high-pressure air may continue to enter plenum 121. Since the resulting elevated pressure will be communicated to the above-described chamber 124 via through-bore 125 of piston 122, the high pressure in chamber 124 will keep piston 122 at the far limit (to the right, in FIG. 9) of its permitted travel. Piston 122 thus can move no further regardless of how high the pressure in chamber 124 rises. However, a through-aperture 163 is provided in piston 122, so that this high pressure can be communicated to the platen of piston 161. As noted, piston 161 is biased by the same spring 123 as piston 122. However, the platen of piston 161 having a smaller surface area than the platen of piston 122, piston 161 will be actuated at a higher pressure than piston 122. Thus if the pressure in chamber 124 rises sufficiently high (e.g., to approximately 13 bar), piston 161 will separate from piston 122 and will move (to the right, in the view of FIG. 9) to a position in which the high-pressure air from chamber 124 can flow between the platens of pistons 122 and 161, around the edges of piston 161, and outward (to the ambient environment) through one or more vent-holes 162 provided in shroud 129 as shown in FIG. 9. Such an arrangement can provide pressure-relief (e.g. in the case that debris prevents valve seat 126 from fully scaling high-pressure entry 127) while leveraging many of the existing components of the metering assembly of the reducer, thus minimizing any additional complexity of the reducer.

### Arrangements of Air-Delivery Passages of Reducer

As illustrated in FIG. 9, reducer 100 will comprise an air-delivery pathway 130 by which air that is metered by metering assembly 120 can reach to one or more air-delivery outlets for purposes as discussed herein. In some embodiments, such an air-delivery pathway 130 may comprise a first air-delivery passage 133, with a first end 134 that is in fluidic communication with upstream plenum 121 of metering assembly 120 to receive metered, outlet-pressure air therefrom. In some embodiments, a second air-delivery passage 136 may be present, with a first end 137 that meets, and is fluidically connected to, first air-delivery passage 133, and with a second end 138 that meets, and is fluidically connected to, an air-delivery outlet 131. In some embodiments, first air-delivery passage 133 may continue past its intersection with second air-delivery passage 136, to a second end that is in fluidic communication with another air-delivery outlet 132. Air-delivery outlet 131 of second air-delivery passage 136 will be termed a “primary” air-delivery outlet (and may have a delivery hose fixed thereto, whereby air can be delivered to a mask-mountable regulator). Air-delivery outlet 132 of first air-delivery passage 133 will be termed a “secondary” air-delivery outlet. In some embodiments, secondary outlet 132 may have a rescue-breathing hose (or an “airline” hose) 61 fixed thereto, if such an item is present: otherwise, secondary outlet 132 may be fitted with a plug. (Here and elsewhere, by “plug” is meant a blanking plug that seals the inlet or outlet.)

First air-delivery passage 133 may comprise an elongate length and exhibit a long axis: this long axis may be oriented at a first angle (generally indicated by angle 135 of FIG. 9) relative to the above-discussed long axis of the spring-biased piston 122 of metering assembly 120. Second air-delivery passage 136 may similarly exhibit a long axis, with the long axis of second pathway 136 meeting the long axis of first passage 133 at a second angle (generally indicated by angle 139 of FIG. 9). In some embodiments angles 135 and 139 may be at least substantially equal, but oppositely-oriented (as evident in FIG. 9) so that the long axis of second air-delivery passage 136 is at least substantially aligned with the long axis of piston 122 of metering assembly 120. This can have the effect that the primary air-delivery outlet 131 of second air-delivery passage 136 defines a hose-end direction (of a hose that is installed in outlet 131) that is at least substantially aligned with a major axis “M” (as indicated in FIG. 9, and as discussed in detail elsewhere herein) of reducer 100.

In various embodiments, angles 135 and 139 may be within plus or minus 10, 5, or 2 degrees of each other. In some embodiments, angles 135 and 139 may each be approximately 90 degrees, (e.g. so that first air-delivery passage 133 extends straight “upward” in the view of FIG. 9). However, in some embodiments each such angle may be e.g. less than 85, 75, or 70 degrees: in further embodiments each such angle may be e.g. greater than 45, 55, 60, or 65 degrees. (By way of a specific example, angles 135 and 139 as shown in FIG. 9 appear to each be approximately 65-70 degrees.) The use of such angles can provide that secondary air-delivery outlet 132 and primary air-delivery outlet 131 are spaced sufficiently far apart, and oriented in sufficiently different directions, that fixtures and hose-ends that are inserted into each outlet will not interfere with each other or contact each other. Also, such arrangements can ensure that a hose-end (e.g. of a delivery hose) that is connected to outlet 131, and a hose-end (e.g. of a rescue-breathing hose) that is connected to outlet 132, are each oriented in a direction that ensures that the hose can be routed in a desired direction along the backframe and/or harness of the SCBA.

The exemplary arrangements described above, comprising at least a primary air-delivery outlet 131 and a secondary air-delivery outlet 132, provide considerable flexibility in usage. For example, air can be sent to a mask-mounted regulator as usual through primary air-delivery outlet 131, with air also being sent to a donee SCBA through a rescue-breathing hose fixed to secondary air-delivery outlet 132. Or, outside air from an airline hose that is fixed to secondary air-delivery outlet 132, can enter the reducer through secondary air-delivery “outlet” 132 and exit the reducer through primary air-delivery outlet 131 to be delivered to a mask-mounted regulator. In such a case, the outside-sourced air will enter the reducer through “outlet” 132 and will travel through air-delivery passage 136 “backwards”; that is, in a direction opposite the direction that tank air will travel if the tank air is being delivered to a donee SCBA via a rescue-breathing hose.

### Integrated Pneumatic Alerting Device

The structure and functioning of an exemplary integrated pneumatic alerting device 140 will now be described. With reference to FIG. 9, the above-described high-pressure air pathway 110 includes a secondary high-pressure air passage 113 (that, in this case, has multiple portions that meet at an intersection 119) that is fluidically connected to a high-pressure gauge air outlet 114. Secondary high-pressure air passage 113 is also fluidically connected to an integrated pneumatic alerting device 140. Specifically, secondary air passage 113 includes an elongate section 117 that is fluidically connected to an upstream antechamber 141 that is upstream of an elongate piston 142 that is biased by a biasing spring 143. High-pressure air can thus enter antechamber 141; as long as this air is at high enough pressure, the air pressure will overcome the force of biasing spring 143 and will maintain piston 142 in a closed position in which air cannot flow through through-bore 145 of piston 142 to reach element 144, which (as evident e.g. in FIG. 7) is configured to emit a loud high-pitched whistle upon sufficient airflow therethrough. Element 144 will remain quiescent as long as sufficient pressure exists in antechamber 141; however, upon the pressure in antechamber 141 dropping below a predetermined threshold, the air pressure will no longer be sufficient to overcome the force of spring 143, and piston 142 will move to an open position that allows air to flow from antechamber 141 through through-bore 145 of piston 145 to reach element 144. The pressure will be such that sufficient airflow will occur to cause element 144 to emit a piercing whistle.

The above description applies to a pneumatic alerting device that is configured to emit a whistling sound. Other types of pneumatic alerting device are contemplated: for example, some such devices rely on a piston that reciprocates to repeatedly impact a strike plate so as to cause a loud buzzing noise and/or vibrating sensation. Various arrangements disclosed herein may be used with a pneumatic alerting device of this type rather than of a whistling type. It is noted in passing that pneumatic alerting device 140 as depicted in FIG. 9 comprises a plug 147. Such a plug will be impermeable to air (including air at high pressure) and, as discussed elsewhere herein, can be used to factory-seal an opening that was initially present in the main body 101 of reducer 100 to facilitate the machining needed to provide various cavities in main body 101 of reducer 100. As mentioned earlier, pneumatic alerting device 140 as depicted in FIG. 9 is an “integrated” feature of reducer 100, rather than being physically separate from reducer 100 so as to require e.g. a hose to deliver air to the alerting device to function.

A particular feature of integrated pneumatic alerting device 140 and its associated air passageways can be seen in FIG. 9. An elongate section 117 of secondary high-pressure air passage 113 is visible in FIG. 9, as is a flow-restricting constriction 118 through which high-pressure air must pass to enter upstream antechamber 141 of alerting device 140. Such a flow restriction 118 can ensure that when a fluidic connection of reducer 100 to a high-pressure air tank is initially established (e.g. by opening a valve of the air tank), an initial surge of high-pressure air does not rapidly flood the alerting device 140 with high-pressure air e.g. in a manner that might damage any of the components of device 140. In other words, a flow restriction 118 serves to limit the rate at which high-pressure air initially enters the upstream antechamber 141 under certain conditions, but typically does not otherwise affect the functioning of device 140. In the depicted exemplary arrangement, a single flow restriction 118 is used and is located proximate to, and is directly fluidically connected to, upstream antechamber 141.

Any such flow-restricting constriction 118 may be characterized e.g. in terms of its diameter relative to the average diameter of section 117 of secondary air passage 113. In various embodiments, the diameter of a constriction 118 may be less than 45, 40, 35, or 30% of the average diameter of section 117. In further embodiments, the diameter may be greater than 5, 10, 15, or 20% of the average diameter of section 117. In some embodiments, the diameter of a constriction 118 may be at most 1.5, 1.0, 0.8, or 0.6 mm: in further embodiments, the diameter of a constriction 118 may be at least 0.2, 0.3, 0.4, or 0.5 mm. Here and elsewhere, in the case of an entity that is non-circular, an effective diameter (that is, the diameter of a circle with the same area as the non-circular entity) may be used for any such characterization.

In some embodiments, flow-restricting constriction 118 may be an “integral” feature of reducer 100. Here and elsewhere, by “integral” is meant a cavity (whether an internal passage, an internal chamber, an inlet, an outlet, etc.) that is defined at least in significant part by the material of main body 101 of reducer 100, and that is produced by machining main body 101 to remove main-body material to leave the integral feature behind. (The term “integral” is thus used in a different, and more restrictive, manner from the previously-introduced term “integrated.) Thus, constriction 118 is integral to main body 101 rather than being produced by taking a separately-made item (e.g. an orifice plate) and inserting it into a cavity in main body 101. In the present case, constriction 118 is amenable to being integral (and can be machined as a smaller-diameter continuation of the machining path that made section 117 of air passage 113). However, at least one other feature (e.g. another flow-restriction) of reducer 100 may be more suitably provided by way of an inserted item, as discussed later herein. With this possible exception noted, in some embodiments many of the features discussed herein (e.g. any, some, or all of primary and secondary high-pressure air passages 112 and 113, air-delivery pathway 130 and passages thereof, upstream plenum 121 and the cavities into which various components of metering assembly 120 are disposed, upstream antechamber 141 and the cavities into which various components of pneumatic alerting device 140 are disposed) may be integral to main body 101 of reducer 100. This may also hold for various inlets and outlets (e.g. high-pressure air inlet 111, primary and secondary air outlets 131 and 132, high-pressure gauge air outlet 114, and air refill inlet 152); any, some, or all such inlets and outlets may be integral to main body 101. The fact that items such as fittings, plugs. O-rings, latch members, and so on, may be inserted into cavities such as inlets, outlets, passages, chambers, and so on, does not change the fact that the cavities themselves are integral features of main body 101 of reducer 100.

At this point it can be specified out how various directions, axes, and so on, of reducer 100 are referenced and characterized herein. The cross-sectional view of FIG. 9 makes it clear that elongate metering piston 122 of metering assembly 120 exhibits a long axis. As defined herein, a major axis of the reducer will be an axis that is parallel to the long axis of piston 122. This major axis is denoted as axis “M” in FIG. 9. In the depicted design, elongate piston 142 of pneumatic alerting device 140 likewise comprises a long axis, which is also oriented along major axis “M” of reducer 100. Pistons 122 and 142 are thus coplanar and collectively establish a major plane of the reducer, in which major plane the long axis of each of these pistons lie. A minor axis “m” of reducer 100 is defined as an axis that is in this major plane but that is oriented at 90 degrees from the long axis of pistons 122 and 142. Finally, a normal axis “n” of reducer 100 is defined as an axis that is perpendicular to the major plane in which the long axes of pistons 122 and 142 lie. Thus, the cross-sectional view of FIG. 9 is a view looking along the normal axis “n” of reducer 100. Various other Figures are views along other axes (or from a vantage point intermediate to these axes); the “M”, “m”, and/or “n” axes are indicated in various Figures. It is noted that these axes are provided to aid in detailed characterization of various features of reducer 100 and do not imply or require any particular overall orientation of reducer 100 as installed on an SCBA harness 10 worn by a user.

### Air Refill System and Passages

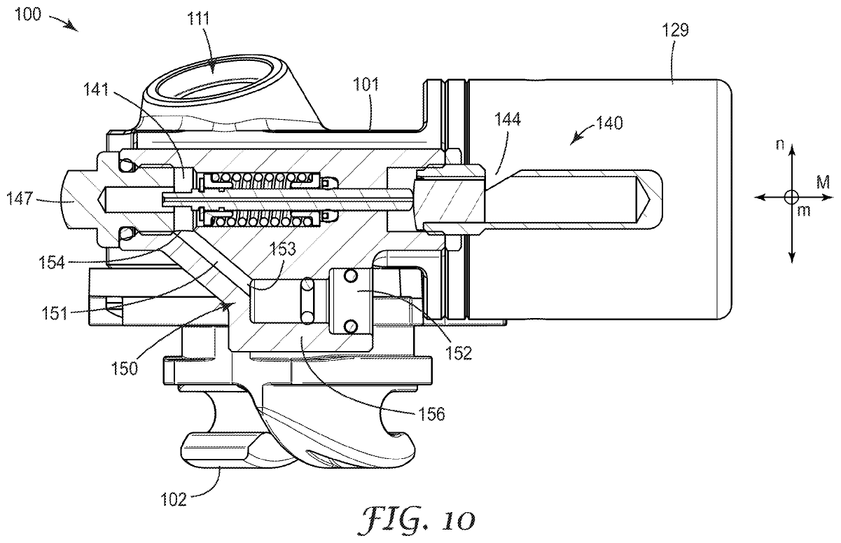

Turning now to FIG. 10, this is a cross-section viewed along the minor axis “m” of the reducer, with the normal axis “n” of the reducer being oriented up and down in the view of FIG. 10. This view allows the arrangement and features of the reducer that facilitate the operation of previously-mentioned air refill system 50 to be observed and discussed. Thus in some embodiments, reducer 100 will comprise an air refill pathway 150 that comprises a refill air inlet 152 that, as evident from FIG. 10, is spaced apart from the above-described pneumatic alerting device 140, generally along the normal axis “n” of the reducer. In other words, refill air inlet 152 is offset along the normal axis “n”, from the major plane established by the above-discussed pistons. Air refill pathway 150 further comprises a refill air passage 151 with a first end 153 that is fluidically connected. e.g. directly fluidically connected, to refill air inlet 152; and, with a second, opposing end 154 that is fluidically connected. e.g. directly fluidically connected to the above-described upstream antechamber 141 of pneumatic alerting device 140. By “directly” fluidically connected means without relying on any intermediary passage or connection: other connections depicted and discussed herein may also be direct connections, without necessarily being specifically identified as such. It is noted in this regard that first end 153 of refill air passage 151 may be considered to be directly fluidically connected to refill air inlet 152, since the entirety of the chamber to which end 153 is connected may be considered to constitute the refill air inlet. In fact, in many circumstances a fitting 54 at a first end 52 of a refill hose 51 that is fixed in inlet 152, may occupy the vast majority of inlet 152 so that the high-pressure air is injected into inlet 152 at a point very close to end 153 of passage 151.

Inspection of FIG. 10 reveals that if an air refill system 50 is used in the manner disclosed herein, high-pressure air (e.g. from an air compressor that feeds air into a refill hose 51) that enters inlet 152 will travel along passage 151 to reach upstream antechamber 141 of pneumatic alerting device 140. Turning now to FIG. 9, the high-pressure air, upon leaving antechamber 141, will travel along section 117 of secondary high-pressure air passage 113 and will then follow air passage 113 (turning at intersection 119) to high-pressure air inlet 111, From there, the high-pressure air will travel via a connecting assembly as described earlier, to high-pressure air tank 11.

It will be appreciated that in such a refill process, high-pressure refill air will be traveling “backwards” along air passage 113 in comparison to the direction that high-pressure air normally travels to reach pneumatic alerting device 140. And, the high-pressure air will travel outward through the previously-described high-pressure air “inlet” 111 to reach air tank 11. These arrangements thus make use of existing high-pressure air pathways, but require high-pressure air to travel through at least some air passages of these pathways in an opposite direction from the “ordinary” direction of airflow therethrough.

Moreover, the above-disclosed exemplary arrangements require the high-pressure refill air that is injected into air refill system 50 to travel through the above-discussed flow-restricting constriction 118. Since the very purpose of this constriction is to slow down the flow of high-pressure air as discussed earlier herein, it is not at all straightforward that a refilling arrangement as disclosed herein can operate properly in the presence of such a flow-restricting constriction. However, the present investigations have revealed that a flow-restricting constriction 118 can be provided that successfully prevents an initial rush of high-pressure air from flooding the alerting device when the valve to the air tank is opened, while not unduly limiting the rate at which high-pressure air can flow in the opposite direction to refill the air tank. (In practice, the arrangements disclosed herein can allow an air tank to be refilled in e.g. 1-2 minutes.)

The above discussions reveal that in the applicant's arrangements, a reducer can be produced that performs multiple functions in addition to a reducer's primary function of receiving high-pressure air and metering the air to a mask-mounted regulator at a suitable lower pressure. These functions may include any or all of (or any subcombination of): supplying air to a high-pressure air gauge, operating a pneumatic alerting device, supplying air to a rescue-breathing system, accepting high-pressure air from an outside source in order to refill a depleted air tank, and accepting outside-sourced, outlet-pressure air via an “airline”. As noted, this may allow the complexity and/or number of external hoses, components, and so on, of the SCBA harness to be minimized. However, this requires creative design of the reducer in order to successfully accomplish such functions. In particular, it is a daunting task to arrange all of the various passages, inlets, outlets, cavities into which components are to be inserted, and so on, in a way that allows many, or even all, of these features to be formed as integral features of the main body 101 of reducer 100, by machining.

### Main Body and Machining

To facilitate a discussion of this topic. FIG. 11 presents a perspective view of a main body 101 of a reducer 100, with all other items omitted. In some embodiments, main body 101 may be obtained from a blank or billet (of e.g. brass) in which external dimensions are formed by machining. However, the arrangements disclosed herein can provide that a billet or blank may be formed into an overall shape e.g. by drop-forging, with machining then being used to impart the fine details of the structure. Regardless of how the external shape of main body 101 is formed, the various internal cavities will usually be formed by machining. As will be well understood, such machining typically involves bringing a rotating machine tool into contact with a starting piece and removing material as the rotating machine tool is moved along a given direction. e.g. to provide an elongate passageway. As customarily practiced, machining of internal passages is performed along various linear or substantially-linear directions, generating smaller diameter cavities along the path of travel of the machine tool (it being understood that it is very difficult to internally machine around corners, to machine a smaller-diameter cavity followed by a larger-diameter cavity along the path of travel, and so on). In some embodiments, it may be possible for some such cavities to be made by other machining methods. e.g. water-jet cutting or laser cutting. However, similar limitations apply; such methods typically cannot go around internal corners, cannot expand from a smaller diameter to a larger diameter along the cutting path, and so on.

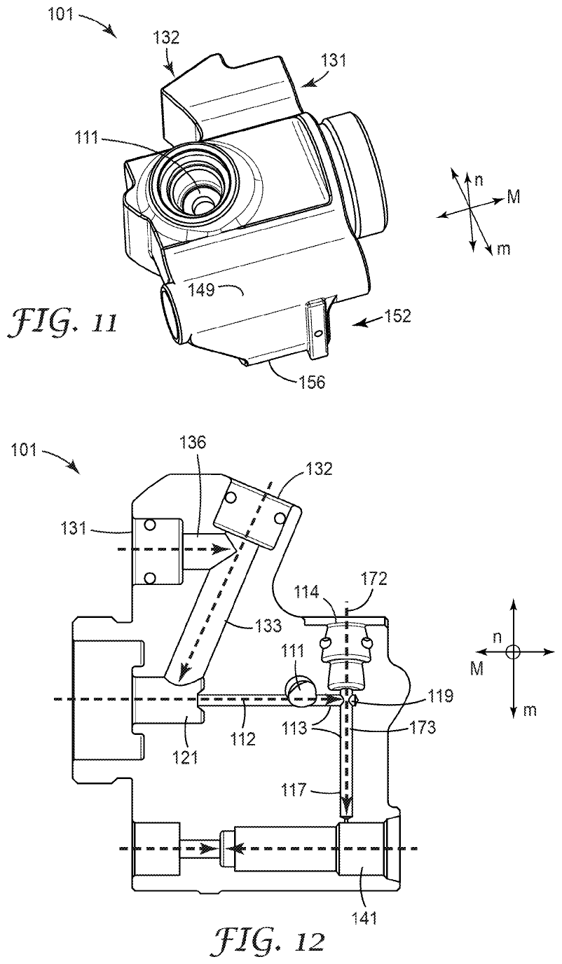

With the above as background, a cross-sectional view of main body 101 of reducer 100 is depicted in FIG. 12, in order to illustrate and discuss the machining issues that arise in producing a reducer 100 as disclosed herein. FIG. 12 is viewed from along the normal axis “n” of the main body (as with FIG. 9), thus showing a planar cut that coincides with the previously-described major plane of the reducer. Superimposed on this view are various arrows that denote different linear machining directions along which machine tools can be moved to subtractively provide the various cavities. It will be appreciated that multiple linear machining processes, along multiple directions, are needed (six such machining directions are denoted in FIG. 12, although not all are identified individually). Other machining directions (e.g. to produce high-pressure air inlet 111) that are oriented so that they are not aligned with the major plane shown in FIG. 12, will also be needed.

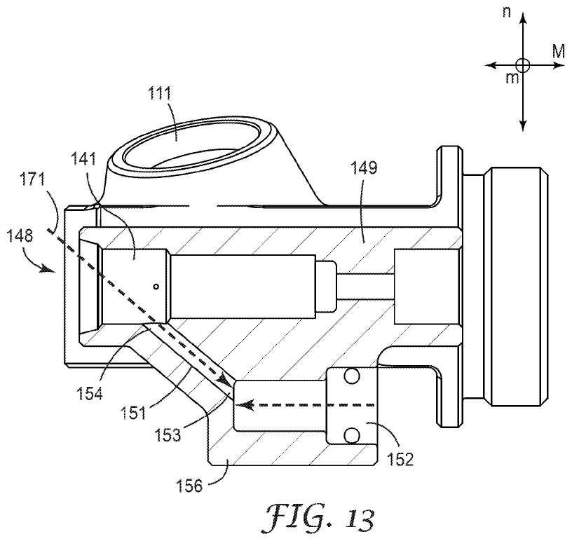

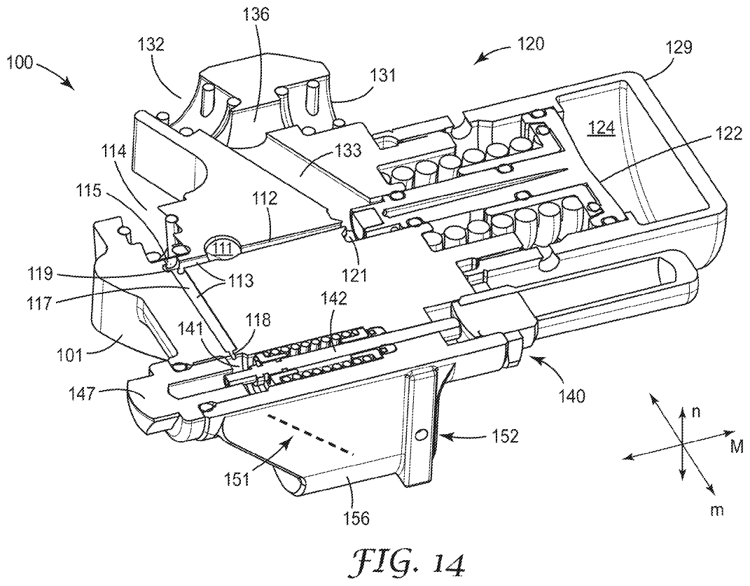

One such machining direction is indicated in FIG. 13, which is a cross-sectional view that is rotated 90 degrees from that of FIG. 12, so that main body 101 is viewed along its minor axis “m” in FIG. 13. This view reveals the machining direction (unnumbered) used to generate refill air inlet 152, and also reveals a machining direction 171 (not visible in FIG. 12) used to generate refill air passage 151. FIG. 13 reveals that the angling of air passage 151 (relative to the long axis of the cavities within which various components of the pneumatic alerting device 140 are disposed) allows air passage 151 to be machined along direction 171 by inserting a machine tool through the open end 148 of what will eventually become the upstream antechamber 141 of pneumatic alerting device 140. In other words, before the previously-described plug 147 is fixed into open end 148 to permanently close it, the presence of open end 148 allows the machining that is necessary to create air passage 151.

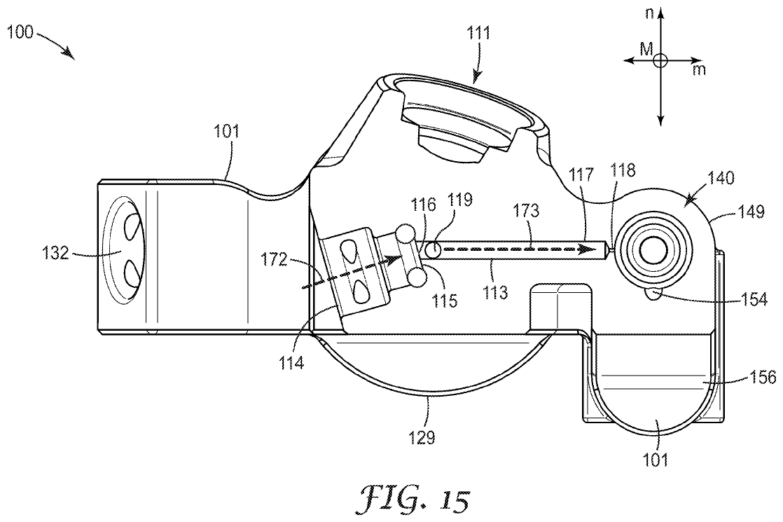

Such an arrangement can provide that refill air passage 151 and upstream antechamber 141 are configured so that the entirety of the elongate length of refill air passage 151, from its second end 154 where it meets antechamber 141, to its first end 153 where it meets refill air inlet 152, will be line-of-sight visible through an opened end 148 of antechamber 141 (emphasizing again that end 148 of antechamber 141 will be closed by plug 147 in the reducer in its final, manufactured form: any removal of the plug would be for the purpose of confirming the above-described configuration). In the depicted arrangement, refill air passage 151 is oriented at an angle relative to the previously-described section 117 of high-pressure air passage 113, as can be seen from FIG. 14, in which the approximate position and orientation of refill air passage 151 is indicated (by a dashed line) relative to antechamber 141 and section 117 of air passage 113. In various embodiments, the angle between passage 151 and passage 113 may be at least 20, 40, 60, or 80 degrees: in further embodiments, this angle may be at most 120, 110, 100, or 105 degrees. The refill air passage 151 may also be characterized by its angle relative to the long axis of the second spring-biased piston 142 of the integrated pneumatic alerting device 140. In various embodiments, this angle may be at least 20, 25, 30, or 35 degrees; in further embodiments, this angle may be at most 70, 60, 50, or 45 degrees. By way of a specific example, the actual angle as depicted in FIG. 13 is approximately 40 degrees (noting that even though piston 142 is omitted from FIG. 13, the orientation of the long axis of piston 142 is easily ascertained by comparing FIG. 13 to FIGS. 9 and 10).

Exemplary arrangements of this type may be further characterized in terms of a refill insertion axis that is defined by refill air inlet 152: such an insertion axis will be the axis along which a first end of a refill hose is inserted into refill air inlet 152 (such a refill insertion axis will correspond to a third hose-end direction as discussed later herein). In some embodiments, such a refill insertion axis may be at least substantially parallel to the long axis of previously-mentioned first piston 122 of metering device 120 and to the long axis of previously-mentioned piston 142 of pneumatic alerting device 140. The refill insertion axis may however be offset from a common plane (i.e., a major plane of reducer 100, as previously described) in which the first and second pistons are located. To achieve this, the refill air inlet 152 may be situated in a refill pod 156 that integrally extends from the main body of the reducer in a direction at least generally normal to the common plane in which the first and second spring-biased pistons are located, as evident in FIG. 11. In some embodiments, refill pod 156 may integrally extend from an integral nacelle 149 in which pneumatic alerting device 140 is disposed (pod 156 and nacelle 149 are most easily seen in FIGS. 11 and 15). Such an arrangement can facilitate a geometric relationship of refill air inlet 152 relative to antechamber 141 of the (incipient) pneumatic alerting device 140 that allows refill air passage 151 to be machined between inlet 152 and antechamber 141 during the time that antechamber 141 has an open end 148.

Another example of the complexities that must be dealt with when attempting to ensure that the various cavities of main body 101 of reducer 100 are able to be produced by machining is illustrated by comparison of FIGS. 12 and 15. FIG. 15 is a cross-sectional view along a direction (looking along the major axis “M” of main body 101) that reveals that high-pressure gauge air outlet 114 is turned at an angle relative to section 117 of secondary high-pressure air passage 113. (This feature of outlet 114 is not easily discernable in the view of FIG. 12.) As will be discussed later, reducer 100 may be mounted on a harness backframe so that outlet 114 is rotated inwardly (i.e., forwardly, toward the backframe) in a manner that can allow a high-pressure gauge hose 41 that is fixed to outlet 114, to be routed inwardly of any other hose that may be nearby. It will be appreciated that, as indicated in FIG. 15, a first machining step along direction 172 can be performed to generate outlet 114. After this, a subsequent machining step along direction 173 can be performed to generate section 117, including constriction 118 (thus, what appears to be a single machining direction 172/173 in FIG. 12, is actually two separate machining directions 172 and 173).

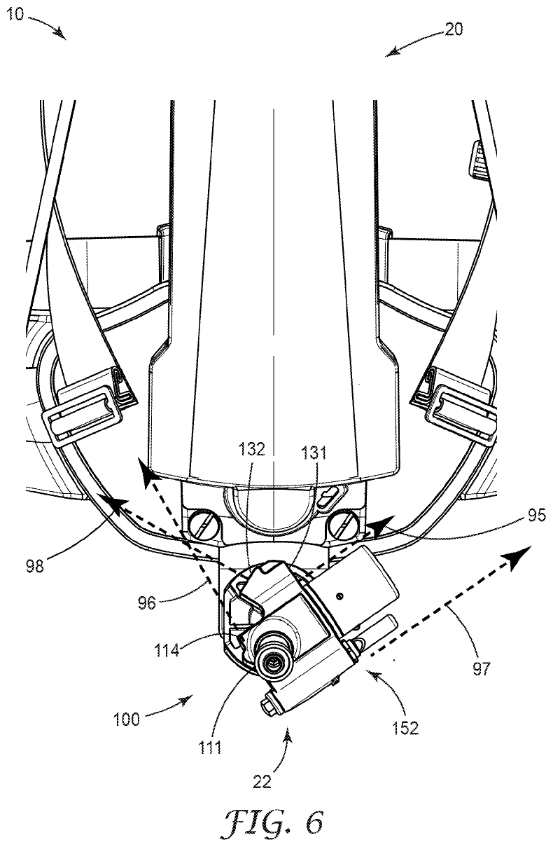

The angle of outlet 114 can be chosen so that the desired “angling” effect on a high-pressure gauge hose 41 that is fixed to outlet 114 can be achieved, while nevertheless allowing machining to be performed through outlet 114, along the subsequent machining direction 173. (It is noted that the portion of main body 101 that comprises outlet 132 does not interfere with machining along direction 172 or direction 173, as is evident from FIG. 9.) This aspect of outlet 114 can be characterized by way of a hose-end direction along which the end of a hose 41 will be oriented when the end of the hose is fixed in outlet 114 (this direction will coincide with machining direction 172, and corresponds to hose-end direction 96 as shown in FIG. 6). In various embodiments, the angle of such a direction relative to passage section 117 may be at least 5, 10, 12, or 14 degrees. In further embodiments, this angle may be at most 40, 30, 25, 20, 18, or 17 degrees. (By way of a specific example, this angle appears to be approximately 14-17 degrees in the exemplary arrangement of FIG. 15.)

In some embodiments, the high-pressure air pathway of reducer 100 may be equipped with a flow-restriction that is positioned and arranged to limit any flow that may occur out of high-pressure gauge air outlet 114. This can provide that e.g. in the event that a high-pressure gauge hose 41 is damaged (or the pressure gauge 40 itself is damaged in such a way that causes it to leak high-pressure air) any air loss will be held to an appropriately low rate. It has been found that such a flow restriction may need to be so small in diameter that it might be difficult to machine into main body 101 as an integral feature thereof. Accordingly, in the arrangement depicted in FIG. 15, a flow restriction is provided by way of an orifice plate 115 comprising an orifice 116. Orifice plate 115 is made (and orifice 116 provided therein) separately from main body 101, and is inserted into place during the manufacture of reducer 100. In the depicted embodiment, orifice plate 115 is positioned at an inward end of high-pressure gauge air outlet 114, between outlet 114 and secondary high-pressure air passage 113. Orifice plate 115 may be held in place in any suitable manner. e.g. with one or more O-rings being provided to ensure an adequate seal against high-pressure air. In various embodiments, orifice 116 of orifice plate 115 may comprise a diameter that is less than 25, 20, 17, 15, 12, 10, 8.0, or 6.0% of the average diameter of secondary high-pressure air passage 113. In further embodiments, the diameter of orifice 116 may be more than 1.0, 2.0, 3.0, 4.0, 5.0, 7.0, 9.0, or 11% of the average diameter of passage 113. In various embodiments, the diameter of orifice 116 may be less than 0.4, 0.35, 0.30, 0.25, 0.20, 0.15, or 0.13 mm. In further embodiments, the diameter of orifice 116 may be more than 0.05, 0.08, 0.12, 0.14, 0.18, or 0.24 mm.

### Reducer Mounting on Backframe

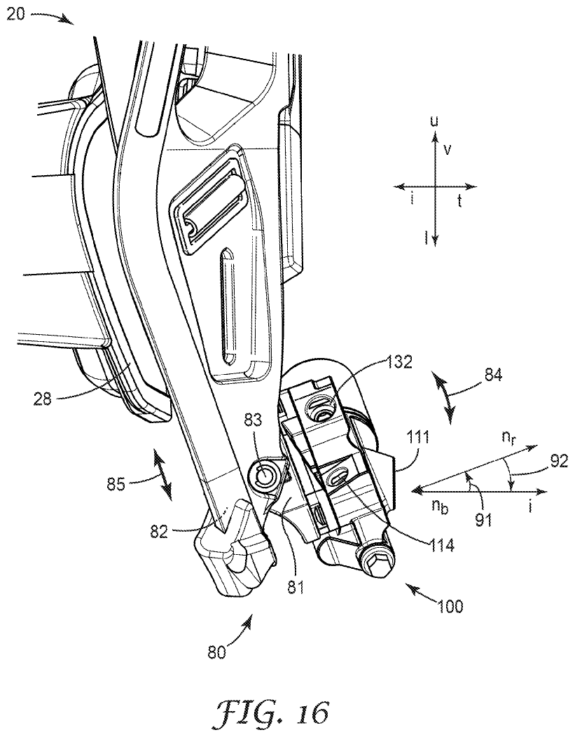

Reducer 100 will be mounted on backframe 20, e.g. by way of being connected to a cradle 80 located at the lower end 22 of backframe 20 in the general manner depicted in FIGS. 4 and 16 (noting that in FIG. 16, air hoses and various other items have been omitted so that remaining items may be easily seen). In some embodiments, this may be achieved by providing reducer 100 with a connector 102, most easily seen in FIGS. 8 and 10. Connector 102 may be a separately-made item that is attached (e.g. with screws or bolts 103) to main body 101 of reducer 100, and connector 102 may comprise first and second arms 104 that are configured to capture an elongate shaft 83 of cradle 80 therebetween. Arms 104 will establish an elongate channel in which shaft 83 will reside. As evident e.g. from FIG. 8, connector 102 can be configured so that this elongate channel is at an angle to the previously-mentioned major axis “M” and minor axis “m” of reducer 100. This can allow reducer 100 to be mounted on backframe 20 so that axes “M” and “m” are at off-angles with respect to the vertical axis of the backframe (as evident in FIGS. 2 and 5), for purposes that will be made clear later. In some embodiments reducer 100 may be able to pivot up and down at least somewhat (as indicated by arrow 84 of FIG. 16), along an axis of rotation defined by shaft 83, with shaft 83 being oriented along the lateral axis of the backframe. This arrangement can allow reducer 100 to be rotated at least slightly, along a direction that is aligned with the vertical axis of the backframe, for purposes that are made clear below.

In some embodiments, connector 102 may be connected. e.g. permanently connected, to a first part 81 of cradle 80 as shown in FIG. 16. First part 81 of cradle 80 may be separable from a second part (e.g. part 82, not visible in FIG. 16) of cradle 80, which second part 82 of cradle 80 may remain permanently attached to lower end 22 of backframe 20. This can allow reducer 100 to be removed from backframe 20 (e.g. in order to clean backframe 20) by detaching cradle part 81 (and reducer 100) from cradle part 82.

In some embodiments, cradle 80 may be configured so that reducer 100 is positioned with the previously-described normal axis of reducer 100 at a first, upward angle relative to the normal axis of backframe 20 (this normal axis of backframe 20 is equivalent to the previously-described inward-outward axis of backframe 20). In FIG. 16, the normal axis of reducer 100 is designated “n”, the normal axis of backframe 20 is designated “n_{b}”, and the first, upward angle between the normal axis of the reducer and the normal axis of the backframe is indicated as angle 91.

Reducer 100 will have a high-pressure air inlet 111 as previously described. Inlet 111 will define an insertion axis along which a high-pressure air inlet fitting of the reducer, and a fitting of a high-pressure air tank, can be moved relative to each other in the process of attaching the fitting of the high-pressure air tank and the high-pressure air inlet fitting of the reducer to each other. (These two fittings will collectively form a connecting assembly a discussed elsewhere herein.) In some embodiments, inlet 111 may be configured so that this insertion axis (designated as axis “i” in FIG. 16) will be at a second, downward angle 92 relative to the normal axis “nᵣ” of the main body of the reducer.

In some embodiments, first angle 91 and second angle 92 may be at least substantially equal in magnitude (i.e., within plus or minus 10, 5, or 2 degrees of each other) but oppositely oriented (that is, one is upward and one is downward). This can provide that the two angles effectively offset each other with the result that the insertion axis “i” defined by the air inlet 111 (and by a fitting that is fixed therein) is at least substantially aligned (e.g. within plus or minus 10, 5 or 2 degrees) with the normal axis “no” of the backframe, as evident in FIG. 16 in which axes “i” and “no” coincide. This will have the effect that when an air tank 11 is mounted on the outward (rear) side of the backframe in the general manner shown in FIG. 4, the fitting of the air tank will be at least substantially positioned along, and aligned with, the insertion axis “i” of the reducer, so that the fitting of the high-pressure air tank and the fitting of the reducer can be moved toward each other along the insertion axis to be attached to each other. This can be achieved while orienting reducer 100 so that its “upper” portion (as mounted on the backframe) exhibits a pronounced inward (forward) tilt as evident in FIG. 16, which can advantageously orient various hoses that are connected to reducer 100, inward toward backframe 20. In various embodiments, first and second offsetting angles 91 and 92 may each be at least about 5, 10, 13, 15, or 17 degrees; in further embodiments, these angles may be at most 40, 30, 27, 25, or 23 degrees. (In the exemplary illustration of FIG. 16, these angles are each approximately 20 degrees.)

The above characterizations apply with reducer 100 pivoted about axis of rotation 83 as described above, to a position in which the above angles are “exactly” offsetting. This will be referred to as a “nominal” position of reducer 100. In actuality, reducer 100 may occasionally need to be rotated slightly from this “nominal” position, depending e.g. on the diameter of the air tank 11 that is to be mounted on the backframe. The “nominal” position may be set e.g. based on the largest (and/or the most common) diameter air tank that is used with backframe 20. Air tanks of slightly differing diameter may cause the fitting of the air tank to be positioned at a slight upward or downward angle as the fitting approaches reducer 100. Thus in some designs reducer 100 may be mounted to backframe 20 so as to be pivotable about axis of rotation 83 in the general manner indicated by arrow 84 of FIG. 16 and as described above; that is, to account for slight angular variations that may occur with air tanks of differing diameter. In some embodiments cradle portion 81 may be able to be slidably moved up and down along cradle portion 82, as indicated by arrow 85 of FIG. 16; however, in other embodiments cradle portion 81 may be fixed and unable to move up and down relative to backframe 20.

As noted, reducer 100 may be connected to air tank 11 by way of a connecting assembly that establishes fluidic pathway whereby high-pressure air from the tank can enter reducer 100, and that can also establish a robust mechanical connection between the reducer and the air tank. In some embodiments, such a connecting assembly may be collectively provided by a fitting that is fixed in the high-pressure air inlet of the reducer and a fitting that is fixed in an outlet of a valve that is fixed in an opening of the air tank. An exemplary connecting assembly 210 is indicated in FIG. 4; this particular connecting assembly is a screw-connection (threaded) assembly that relies on a fitting 211 that is fixed to an outlet of a valve of air tank 11, acting in combination with a fitting 212 that is fixed in in a high-pressure air inlet of reducer 100. The appropriate components of these fittings comprise threads, and a handwheel 213 is provided (as part of fitting 212) that can be rotated to threadably attach the fittings together to establish a robust connection therebetween. (Handwheel 213 is omitted from FIGS. 5 and 6 so that other components can be more easily seen.)

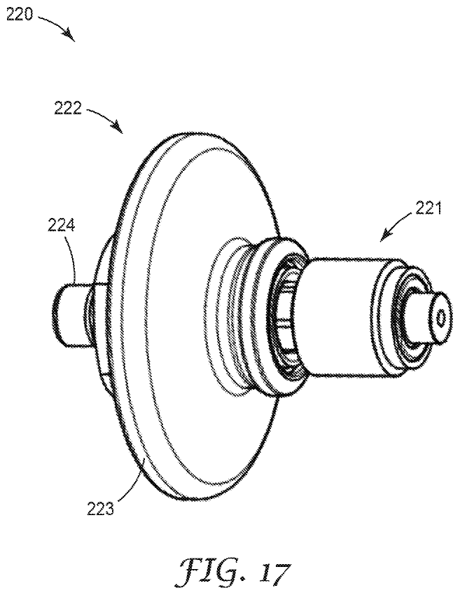

In some embodiments, a connecting assembly 220 of the general type shown in FIG. 17 may be used. Such a connecting assembly may be collectively provided by a fitting 222 that is fixed in the high-pressure air inlet of the reducer and a fitting 221 that is fixed in an outlet of a valve that is fixed in an opening of the air tank. The fitting 221 may comprise a probe that is configured to be accepted into a recess of fitting 222. The fittings (which are shown joined together in FIG. 17) may be separated from each other by pushing the fittings toward each other and then moving flanged portion 223 (to the left, in FIG. 17) so that portion 223 retracts relative to portion 224 of fitting 222. This push-pull operation will free fitting 221 so that it can be separated from fitting 222. The fittings can be rejoined to each other by moving the two fittings toward each other so that the probe of fitting 221 enters the receptable of fitting 222, to the point that portion 223 will be freed and (under the urging of a biasing force provided by an internal spring) will click forward into place to secure the fittings to each other. Fittings that are connectable in this general manner are often referred to as quick-connect fittings. (Here and elsewhere herein, the terminology of moving entities (e.g. two fittings, and thus the air tank and SCBA harness/backframe associated therewith) relative to each other encompasses situations in which one, the other, or both, such entities are moved.) With quick-connections of this general type, it may be advantageous for flanged portion 223 to be sufficiently large that, for example, it can be easily grasped and manipulated even by a user wearing thick gloves.

As noted earlier, in some embodiments reducer 100 may be a load-bearing item that, in addition to the other uses discussed herein, may support at least some of the weight of the air tank and may transmit a significant portion of the load resulting from the weight of the air tank, to the backframe. In such cases, a connecting assembly that is used to connect the reducer to the air tank, should have mechanical strength commensurate with such a function (as well as being able to withstand the high air pressures involved).

### Arrangements and Routing of Air Hoses

As discussed earlier herein, an SCBA harness will comprise a number of hoses configured to carry air to and from reducer 100 for various purposes. Ideally, such hoses should be routed to their destination in the most efficient manner (e.g. along the shortest, most direct path) and should be adequately protected along their journey. If possible, such hoses should be arranged and routed so that the hoses approach each other (in particular, cross over each other) as few times as possible, so that they have minimal contact with each other to avoid rubbing or abrasion. (Here and elsewhere, the terminology of hoses crossing over each other is evaluated when viewing the hoses along the inward-outward, normal axis of the harness.) Such arranging and routing of air hoses is increasingly difficult as SCBA harnesses are equipped with electronic components and equipment such as monitoring systems, communication and telemetry systems, and so on. Such systems require e.g. processing modules, instrumentation or sensors, displays, one or more power sources, and so on, that can occupy a significant portion of the space available on an SCBA harness.

The arrangements disclosed herein address such problems in part by integrating as many functions as possible into the reducer of the SCBA, which can reduce the number of items that the SCBA harness needs have room for. For example, the herein-disclosed arrangements can eliminate any need for a harness-mounted pneumatic alerting device and a hose to deliver high-pressure air to the device, and can eliminate any need for a dedicated, harness-mounted assembly/fixture for refilling the air tank. However, other exemplary arrangements are possible that provide additional benefits. In particular, a reducer 100 may be configured so that various air inlets and/or outlets are positioned and oriented so as to route various hoses in directions that are optimally suited in view of the destination of such hoses and the space available for such hoses.

For example, reducer 100 may be configured for optimal positioning of a previously-described primary air-delivery outlet 131 to which a delivery hose 31 is fixed in order to deliver air to a mask-mounted respirator. With reference to FIGS. 5 and 6, outlet 131 will define a first hose-end direction 95 along which the first end 32 (and a fitting 34 thereof) of delivery hose 31 is oriented. The position and orientation of outlet 131 on reducer 100 may be chosen in combination with the orientation in which reducer 100 is mounted on the lower end 22 of backframe 20, so that the first hose-end direction 95 defined by outlet 131 is at a suitable upward angle as shown in FIG. 6. As shown in FIG. 5, this can have the result that hose 31, as it leaves reducer 100, is oriented generally upward, and laterally outward. This allows hose 31 to be routed upward along backframe 20 in the manner shown in FIG. 5. e.g. along a path that is laterally outward of a first lateral edge 25 of a backframe electronics module 27 that is laterally centrally located in backframe 20. Hose 31 can thus be efficiently routed upward toward its final destination (a mask-mounted regulator) even in the presence of e.g. a bulky electronics module that is mounted in the backframe.

In various embodiments, first hose-end direction 95 will be oriented upward and may exhibit an angle relative to the vertical axis of the backframe of at least 20, 30, 40, 50, or 55 degrees. (Here and elsewhere, all such angles between a direction and a vertical axis, and between directions, will be an included angle.) In further embodiments, this included angle may be at most 80, 70, 65, or 60 degrees. By way of a specific example, the first hose-end direction 95 as shown in FIG. 6 exhibits an included angle of approximately 55-60 degrees.

Reducer 100 may also be configured for optimal positioning of a previously-mentioned high-pressure gauge air outlet 114 to which a high-pressure gauge hose 41 is fixed in order to deliver air to a high-pressure gauge. With reference to FIGS. 5 and 6, outlet 114 will define a second hose-end direction 96 along which the first end 42 of high-pressure gauge hose 41 is oriented. The position and orientation of outlet 114 on reducer 100 may be chosen in combination with the orientation in which reducer 100 is mounted on the lower end 22 of backframe 20, so that the second hose-end direction 96 defined by outlet 114 is at a suitable upward angle as shown in FIG. 6. As shown in FIG. 5, this can have the result that hose 41, as it leaves reducer 100, is oriented generally upward, and laterally outward. This allows hose 41 to be routed upward along backframe 20 in the manner shown in FIG. 5, e.g. along a path that is laterally outward of a second lateral edge 26 of a backframe electronics module 27. Hose 41 can thus be efficiently routed upward toward its final destination (a pressure gauge) even in the presence of e.g. a bulky electronics module that is mounted in the backframe.

In various embodiments, second hose-end direction 96 will be oriented upward and may exhibit an included angle relative to the vertical axis of the backframe of at least 10, 20, 30, 40 or 50 degrees. In further embodiments, this included angle may be at most 70, 60, 50, 40, or 35 degrees. By way of a specific example, the second hose-end direction 96 as shown in FIG. 6 exhibits an included angle of approximately 30-35 degrees.

It will be appreciated that in the depicted exemplary arrangement, outlets 131 and 114 are positioned and oriented so as to respectively route hoses 31 and 41 along diverging pathways that can pass e.g. along opposite lateral edges of the backframe. This has the effect that hoses 31 and 41 do not have to cross over each other at any point along their respective routings. The relationship between first and second hose-end directions 95 and 96 may be characterized in terms of the angle between these directions. In various embodiments, an included angle between directions 95 and 96 may be at least 20, 40, 60, or 80 degrees. In further embodiments, such an angle may be at most 140, 120, or 100 degrees. In the exemplary arrangement of FIG. 6, the angle between directions 95 and 96 is approximately 90 degrees.

Reducer 100 may also be configured for optimal positioning of the previously-mentioned refill air inlet 152 to which a refill hose 51 may be fixed in order to receive high-pressure air from an external source. With reference to FIGS. 5 and 6, inlet 152 will define a third hose-end direction 97 along which the first end 52 of refill hose 51 is oriented. The position and orientation of inlet 152 on reducer 100 may be chosen in combination with the orientation in which reducer 100 is mounted on the lower end 22 of backframe 20, so that the third hose-end direction 97 defined by inlet 152 is at a suitable upward angle as shown in FIG. 6. As shown in FIG. 5, this can have the result that hose 51, as it leaves reducer 100, is oriented generally upward, and laterally outward. This allows hose 51 to be routed generally laterally along a first lateral section 12 of the waist strap of the SCBA harness in the general manner described earlier herein. Notably, refill hose 51 will not cross over delivery hose 31 or high-pressure gauge hose 41 at any point along the elongate length of the hoses. Hose 51 can thus be efficiently routed laterally outward toward its final destination (e.g. a refill fitting 55 that is secured to a waist strap of the harness) without crossing over any other hoses.

In various embodiments, third hose-end direction 97 will be upward and may exhibit an included angle relative to the vertical axis of the backframe of at least 20, 30, 40, 50, or 55 degrees. In further embodiments, this included angle may be at most 80, 70, 65, or 60 degrees. By way of a specific example, the third hose-end direction 97 as shown in FIG. 6 exhibits an included angle of approximately 55-60 degrees. In some embodiments, third hose-end direction 97 defined by refill air inlet 152 may be aligned within plus or minus 10, 5, or 2 degrees of parallel to the above-mentioned first hose-end direction 95 defined by primary air-delivery outlet 131. In some embodiments (regardless of the particular angle between directions 95 and 97), reducer 100 may be positioned and oriented on backframe 20 so that refill air inlet 152 is generally below primary air-delivery outlet 131. Such arrangements can efficiently route delivery hose 31 generally upward and somewhat laterally outward, and refill hose 51 generally laterally outward and somewhat upward, toward their respective destinations without crossing each other, as is evident from FIG. 5.

Reducer 100 may also be configured for optimal positioning of a previously-mentioned secondary air-delivery outlet 132 to which a rescue-breathing (and/or, airline) hose 61 may be fixed in order to deliver air to a donee SCBA. With reference to FIGS. 5 and 6, outlet 132 will define a fourth hose-end direction 98 along which the first end 62 of hose 61 is oriented. The position and orientation of outlet 132 on reducer 100 may be chosen in combination with the orientation in which reducer 100 is mounted on the lower end 22 of backframe 20, so that the fourth hose-end direction 98 defined by outlet 132 is at a suitable upward angle as shown in FIG. 6. As shown in FIG. 5, this can have the result that hose 61, as it leaves reducer 100, is oriented generally upward, and laterally outward. This allows hose 61 to be routed generally laterally along a second lateral section 13 of the waist strap of the SCBA harness in the general manner described earlier herein. In various embodiments, fourth hose-end direction 98 will be upward and may exhibit an included angle relative to the vertical axis of the backframe of at least 20, 30, 40, 50, or 55 degrees. In further embodiments, this included angle may be at most 80, 70, 65, or 60 degrees. By way of a specific example, the fourth hose-end direction 98 as shown in FIG. 6 exhibits an included angle of approximately 55-60 degrees.

In the depicted exemplary embodiment, rescue-breathing (and/or airline) hose 61 will not cross over delivery hose 31 or refill hose 51 at any point along the elongate length of these hoses. However, in the depicted exemplary arrangement, hose 61 will outwardly (rearwardly) cross over high-pressure gauge hose 41 at a crossing point 66, as indicated in FIG. 5. It is also evident (in FIG. 6) that in the depicted arrangement, secondary air-delivery outlet 132 is oriented so that fourth hose-end direction 98 is oriented more laterally outward in comparison to the second hose-end direction 96, which is oriented more upwards. (In other words, direction 98 has a larger included angle relative to the vertical axis of the backframe, than does direction 96.) This can ensure that, as evident from FIG. 5, the crossing point 66 of hoses 61 and 41 is located close to (e.g. less than 5, 4, 3 or 2 cm from) reducer 100. This can have the advantageous effect that, at the crossing point, the hoses are relatively immobile since the crossing point is close to the ends of the hoses that are fixed (hence immobilized) in the outlets.

Still further (and as alluded to earlier) in some embodiments high-pressure gauge air outlet 114, and thus second hose-end direction 96 defined thereby, may have a pronounced inward tilt in relation to the major plane of the reducer, and in particular in relation to secondary air-delivery outlet 132 and fourth hose-end direction 98 defined thereby. This is not visible from the viewpoint of FIG. 5 but is evident in the views of FIGS. 15 and 16. Such an arrangement can provide that high-pressure gauge hose 41 is routed sufficiently far inward of rescue-breathing hose 61 that the two hoses are unlikely to contact each other at crossing point 66. In various embodiments, second hose-end direction 96 may be oriented at an inward angle relative to fourth hose-end direction 98, of at least 5, 10, 12, or 14 degrees. In further embodiments, this angle may be at most 30, 25, 20, 18, or 16 degrees. (In the exemplary embodiment depicted in FIGS. 15 and 16, this inward angle appears to be approximately 14-16 degrees.)

The arrangements described above can provide that hoses 41 and 61 will have an inward-outward gap between them at their crossing point 66; and, that they have minimal ability to move relative to each other at the crossing point (since crossing point 66 is so close to the hose-ends). Such arrangements can ensure that hoses 41 and 61 have only minimal contact with each other, or no contact at all.

In some embodiments, at least the above-described primary air-delivery outlet 131 and high-pressure gauge air outlet 114 will be integral to the main body of the reducer, in the manner previously defined and described. In further embodiments, the refill air inlet 152 and/or the secondary air-delivery outlet 132 will also be integral to the main body of the reducer. Such arrangements can provide that the above-described positioning and routing of various hoses can be achieved via the integral inlets and/or outlets of the reducer, as made, without having to equip the reducer with an added manifold. A manifold is a separately-made, rigid shroud or shell that is attached to a reducer and that receives air from at least one outlet of the reducer and redirects the air to an outlet of the manifold that is oriented in a desired direction. While the use of a manifold may allow hose routing to be improved, a manifold adds weight and complexity, and potential leak points, to a reducer. Accordingly, the arrangements herein, which can achieve various objectives without resorting to a manifold, provide significant advantages.

In summary, a reducer can be configured and oriented in the general manner disclosed herein so as to not only efficiently route various hoses to their destinations, but also to ensure that a minimum number (e.g., one) of hose cross-overs occurs; and, to ensure that at a crossing point, minimal or no contact occurs between hoses. It will be appreciated that such arrangements rely on creative arrangement and manipulation of the geometry and features of reducer 100 and cannot be considered to be, for example, a mere routine optimization of an existing arrangement of hoses. (In particular, the use of terms such as “optimal” in the present disclosure shall not be taken as implying that any arrangement described in such terms, is a result of routine optimization.) Furthermore, the arrangements disclosed herein can achieve various technical effects (e.g. enabling a reducer to perform multiple functions, advantageous routing of multiple hoses, and so on) without increasing the size and/or weight of the reducer. (In fact, prototype reducers of the type described herein are lighter in weight than various currently-available reducers.)

In some instances, a user may prefer to use an SCBA that, as supplied to the user, does not comprise an air refill system 50, and/or that does not comprise a rescue-breathing system 60 and/or is not airline-ready. That is, in some embodiments such functionalities may be optional features of an SCBA. In such cases, the high-pressure air refill inlet 152, and/or the secondary air-delivery outlet 132, of reducer 100, may be filled (at the factory) with a plug that effectively seals the inlet or outlet. It will thus be apparent that the arrangements disclosed herein allow a single, generic design of reducer to be used, with one or more inlets or outlets being plugged or having a hose-end fixed thereinto, depending on the particular SCBA configuration that is desired by a user. This is preferable over having to manufacture and stock reducers of multiple different designs to accommodate user preferences. It is noted that a reducer 100, even if inlet 152 and/or outlet 132 is plugged so that a hose is not connected thereto, will still define the respective (e.g. third and fourth) hose-end directions discussed above, even if such a hose is not actually present. Also, if such a reducer comprises an integral refill air passage of the type described herein, it will still be considered that a first end of the integral refill air passage is fluidically connected to a refill air inlet of the reducer, even if the inlet itself is outwardly plugged. That is, in such circumstances the terms “inlet” and “outlet” will have a special definition that encompasses a plugged inlet or outlet.

It was noted earlier herein that in some embodiments, reducer 100 can be removed from backframe 20, e.g. by separating first and second portions of a cradle by which the reducer is connected to the backframe. In some embodiments, the previously-described high-pressure gauge and its high-pressure gauge hose, and the delivery hose and mask-mountable regulator, will be separable from backframe 20 and from the SCBA harness 10 as a whole, with the high-pressure gauge hose and the delivery hose remaining fixed to the reducer when separated from the harness. If the harness comprises a refill hose and/or a rescue-breathing hose, these items may likewise be separable from the backframe and harness, while remaining fixed to the reducer. In this regard it is noted that the term “fixed” as used herein, particularly in regard to a hose-end being “fixed” in an inlet or outlet, denotes a permanent. e.g. factory-installed, condition, such that the hose-end cannot be removed from the inlet or outlet by a user (noting that the hose may be able to rotate slightly in the inlet or outlet, even though it cannot be removed). In short, in some embodiments all of the “pneumatic” items and components of the SCBA harness can be removed from the backframe and harness. e.g. so that the structural components, as well as straps, padding, and so on, of the harness may be more easily cleaned. If a backframe-mounted electronics module of the general type described earlier herein is present, in some embodiments such an electronics module may be removable from the backframe, which again may facilitate cleaning of other components of the backframe harness.

It will be apparent to those skilled in the art that the specific exemplary embodiments, elements, structures, features, details, arrangements, configurations, etc., that are disclosed herein can be modified and/or combined in numerous ways. In summary, numerous variations and combinations are contemplated as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein but to which no priority is claimed, this specification as written will control.

What is claimed is:

1. A reducer for a self-contained breathing apparatus (SCBA), the reducer configured to receive air from a high-pressure air tank at a high, tank pressure through a high-pressure air inlet of the reducer and to deliver the air through at least one air-delivery outlet of the reducer at an outlet pressure that is lower than the high, tank pressure, the reducer comprising:
a metering assembly that is fluidically connected to the high-pressure air inlet by a primary high-pressure air passage and that is configured to accept high-pressure air from the high-pressure air passage and to meter the high-pressure air into an air-delivery pathway at the outlet pressure, the air-delivery pathway of the reducer being fluidically connected to the at least one air-delivery outlet so that the outlet-pressure air can be delivered to the at least one air-delivery outlet;
a secondary high-pressure air passage that is fluidically connected to the high-pressure air inlet and to the primary high-pressure air passage and that is also fluidically connected to a high-pressure gauge air outlet configured to allow the high-pressure air to reach a high-pressure gauge of the SCBA;
an integrated pneumatic alerting device with an upstream antechamber to which the secondary high-pressure air passage is fluidically connected,
wherein the reducer comprises an integral refill air passage with a first end that is fluidically connected to a refill air inlet of the reducer and with a second, opposing end that is fluidically connected to the upstream antechamber of the integrated pneumatic alerting device.

2. The reducer of claim 1 wherein the secondary high-pressure air passage comprises at least one flow-restricting constriction located between the upstream antechamber of the integrated pneumatic alerting device and the high-pressure air inlet, the flow-restricting constriction comprising a diameter that is between 0.3 mm and 0.7 mm and that is between 20 and 30% of an average diameter of the secondary high-pressure air passage.

3. The reducer of claim 2 wherein the at least one flow-restricting constriction is in the form of exactly one integral flow-restricting constriction that is located proximate to, and is directly fluidically connected to, the upstream antechamber of the integrated pneumatic alerting device.

4. The reducer of claim 1 wherein a flow-resisting constriction is provided between the high-pressure gauge air outlet and the secondary high-pressure air passage, the flow-resisting constriction being provided by a non-integral orifice plate having a through-hole comprising a diameter that is between 0.4 mm and 0.01 mm and that less than 20% of an average diameter of the secondary high-pressure air passage.

5. The reducer of claim 1 wherein a portion of the secondary high-pressure air passage that is proximate the upstream antechamber of the integrated pneumatic alerting device is elongate with a long axis, wherein the integral refill air passage is elongate with a long axis, and wherein the long axis of the integral refill air passage is oriented at an angle relative to the long axis of the portion of the secondary high-pressure air passage that is proximate the upstream antechamber of the integrated pneumatic alerting device, of from 20 degrees to 70 degrees.

6. The reducer of claim 1 wherein the high-pressure air inlet of the reducer is defined at least in part by a high-pressure air inlet fitting that is fixedly inserted into an air-inlet-fitting integral receptacle of a main body of the reducer, the receptacle defining an insertion axis along which the high-pressure air inlet fitting of the reducer, and a fitting of a high-pressure air tank, can be moved relative to each other in the process of attaching the fitting of the high-pressure air tank and the high-pressure air inlet fitting of the reducer to each other.

7. The reducer of claim 6 wherein the high-pressure air inlet fitting of the reducer is a push-pull quick-connect fitting configured so that with the high-pressure air inlet fitting of the reducer attached to the fitting of the high-pressure air tank, the quick-connect fitting and the fitting of the high-pressure air tank can be moved toward each other with a movable portion of the quick-connect fitting then being retracted from a non-movable portion of the quick-connect fitting in a direction away from the fitting of the high pressure tank, after which the quick-connect fitting and the fitting of the high-pressure tank can be detached from each other.

8. The reducer of claim 1 wherein the metering assembly of the reducer comprises a spring-biased metering piston with an elongate length and a long axis, and further comprises an upstream plenum that is upstream of the metering piston, that is in fluidic communication with the primary high-pressure air passage in a manner that is interruptible by motion of the metering piston of the metering assembly, and that is in non-interruptible, direct fluidic communication with a first end of a first air-delivery passage of the air-delivery pathway.

9. The reducer of claim 8 wherein the first air-delivery passage of the air-delivery pathway comprises an elongate length and exhibits a long axis, and wherein the long axis of the first air-delivery passage of the air-delivery pathway is oriented at a first angle of between 55 and 75 degrees relative to the long axis of the metering piston of the metering assembly of the reducer.

10. The reducer of claim 9 wherein the air-delivery pathway comprises a second air-delivery passage with a first end that is directly fluidically connected to the first air-delivery passage of the air-delivery pathway and meets the first air-delivery passage at a second angle that is within plus or minus 10 degrees of the first angle so that a long axis of the second air-delivery passage is aligned within plus or minus 10 degrees of the long axis of the metering piston of the metering assembly of the reducer, and wherein a second, opposing end of the second air-delivery passage is directly fluidically connected to a primary air-delivery outlet of the reducer.

11. The reducer of claim 10 wherein a second, opposing end of the first air-delivery passage is directly fluidically connected to a secondary air-delivery outlet of the reducer.

12. The reducer of claim 1 wherein the primary and secondary high-pressure air passages of the reducer, the air-delivery pathway of the reducer, the upstream antechamber of the integrated pneumatic alerting device of the reducer, the integral refill air passage of the reducer, and an upstream plenum of the metering assembly of the reducer, are all integral features of the reducer, formed by machining multiple cavities into a main body of the reducer along multiple linear machining directions.

13. The reducer of claim 12 wherein the integral refill air passage of the reducer and the upstream antechamber of the integrated pneumatic alerting device of the reducer are arranged so that the entirety of an elongate length of the integral refill air passage of the reducer is line-of-sight visible through an opened upstream end of the upstream antechamber of the integrated pneumatic alerting device.

14. An SCBA harness comprising the reducer of claim 1, the SCBA harness comprising:
a backframe with an upper end and a lower end, and an inward side and an outward side, the backframe being configured to support at least one high-pressure air tank on the outward side of the backframe;
a waist strap connected to the backframe and configured to encircle a user's waist and/or hip area;
first and second shoulder straps connected to the backframe and configured to pass over a user's shoulders; and
a mask-mountable regulator that is fluidically connected to the at least one air-delivery outlet of the reducer by a delivery hose that is configured to receive air from the reducer at the outlet pressure and to deliver it to the mask-mountable regulator.

15. The SCBA harness of claim 14 wherein the air-delivery pathway of the reducer comprises a primary air-delivery outlet; and, wherein the delivery hose comprises a first end with a fitting that is fixedly inserted into the primary air-delivery outlet of the reducer, and a second, opposing end that is fluidically connected to the mask-mountable regulator, so as to fluidically connect the primary air-delivery outlet of the reducer to the mask-mountable regulator.

16. The SCBA harness of claim 14 wherein the air-delivery pathway of the reducer further comprises a secondary air-delivery outlet; and, wherein the SCBA harness comprises a rescue-breathing hose or an airline hose, with a first end comprising a first fitting that is fixedly inserted in the secondary air-delivery outlet and a second end comprising a second fitting that is configured to be fluidically connected to a fitting of a donee SCBA or to be fluidically connected to a fitting of an air-supplying umbilical.

17. The SCBA harness of claim 14 wherein the harness further comprises a refill hose with a first end comprising a first fitting that is fixedly inserted in the refill air inlet of the reducer to fluidically connect the first end of the refill hose to the refill air inlet of the reducer, and with a second, opposing end comprising a second fitting that is configured to be removably fluidically connected to an outside source of refill air, and wherein the first fitting of the refill hose comprises a one-way valve that allows flow of refill air into the refill air inlet, but does not allow air to exit out of the refill air inlet.

18. The SCBA harness of claim 14 wherein the harness further comprises a high-pressure gauge hose with a first end comprising a fitting that is fixedly inserted in the high-pressure gauge air outlet of the reducer to fluidically connect the first end of the high-pressure gauge hose to the high-pressure gauge air outlet of the reducer, and with a second, opposing end to which is fluidically connected a harness-mounted high-pressure gauge that is configured to monitor and report the pressure of the high-pressure air.

19. An SCBA comprising the SCBA harness of claim 14, the SCBA further comprising:
at least one high-pressure air tank filled with breathing air at a high, tank pressure, the air tank being secured to the backframe of the SCBA harness and a high-pressure air outlet of the air tank being fluidically connected to the high-pressure air inlet of the reducer; and,
a facemask configured to be worn by a user, the facemask defining an interior region adjacent the user's face when the facemask is donned by the user,
wherein the mask-mountable regulator is mounted on the facemask and is configured to receive air from the delivery hose at the outlet pressure and to admit the air into the interior region defined by the facemask, at a breathing pressure that is lower than the outlet pressure.

20. A method of refilling the air tank of the SCBA of claim 19 with the air tank mounted in place on the backframe of the SCBA and fluidically connected to the reducer of the SCBA, the method comprising:
fluidically connecting a second fitting of a refill hose of the SCBA to an outside source of refill air and injecting refill air from the outside source into the second fitting of the refill hose, so that the refill air travels through the refill hose, into the refill air inlet of the reducer, through the integral refill air passage of the reducer, through the upstream antechamber of the integrated pneumatic alerting device of the reducer, and through the secondary high-pressure air passage of the reducer, to reach the high-pressure air inlet of the reducer, and wherein the refill air exits the high-pressure air inlet of the reducer through a connecting assembly that allows the refill air to enter the air tank.
